(19) United States
(12) Patent Application Publication
(10) Pub. No.: US 2023/0393832 A1
(43) Pub. Date: Dec. 7, 2023

(54) AUTOMATED TRANSLATION OF COMPUTER LANGUAGES TO EXTRACT AND DEPLOY COMPUTER SYSTEMS AND SOFTWARE

(71) Applicant: Incentive Marketing Group, Inc., Arlington, VA (US)

(72) Inventors: Harrison Touati, Arlington, VA (US); Adam Branch, Arlington, VA (US)

(73) Assignee: Incentive Marketing Group, Inc., Arlington, VA (US)

(21) Appl. No.: 18/299,364

(22) Filed: Apr. 12, 2023

Related U.S. Application Data
(60) Provisional application No. 63/349,539, filed on Jun. 6, 2022.

(51) Int. Cl. G06F 8/61; G06F 21/56

(52) U.S. Cl. CPC G06F 8/63; G06F 21/563

(57) ABSTRACT

A computer-implemented system and method for the integration and deployment of software applications, including an extraction module for obtaining data and replicating it in a usable format, including business knowledge and rules from the application source code, a conversion module for translating data from a legacy system to a new format, using Universal Application Notation (UAN), a deployment module for installing, configuring, updating, and enabling applications for use, including automated deployment of newly translated applications, and an integration module for seamlessly integrating new and legacy applications with a chatbot and/or low or no-code integration tools.

### TECHNICAL FIELD

Embodiments of the present disclosure generally relate to data, application, and system migration and translation of computer language into a universal format called Universal Application Notation (UAN). More specifically, the migration uses a single software to extract, convert, and deploy the data, application, or system.

### SUMMARY

Embodiments of the present disclosure relate to methods for extracting, converting, and deploying data from a legacy system to a new system using a universal application notation (UAN). Embodiments also relate to data migration to the cloud.

Companies often need to update their computer systems because they are running on old or outdated software. The present invention allows for automated data extraction from a legacy application or system, conversion of the data to a format useable for the new application or system, and deployment of the data in the new application or system.

The extraction of data from the legacy system or application is performed using automated software that uses artificial intelligence (AI) and machine learning (ML) to find and highlight important data. The important data is extracted and converted into UAN and then into a format usable by the new system or application. The same software then deploys the data into the new system or application. Data migration to the cloud is a major field, but generally needs experts with proprietary software to perform the migration. Data migration is complicated, expensive, and takes a long time. The present invention also allows for the conversion of data from an on-sight server to the cloud.

This disclosure also relates to a universal programming language translator. This translator takes extracted code and converts it to a JSON format for storage. The program can convert JSON to many programming languages after storage, effectively translating a starting code from one language to another. Translations of new languages to JSON can be added to the program when needed, and the scalability of these translations is more manageable than having a translation program for every code needed to be translated.

This summary of the invention is in no way a full, complete, and accurate depiction of the present invention. This summary is not intended to limit the scope of the present disclosure but is instead intended to provide a background to the disclosed method. Other aspects of the disclosure will become apparent from following the detailed description and the figures provided.

Some embodiments include a computer-implemented system for the integration and deployment of software applications, including an extraction module for obtaining data and replicating it in a usable format, including business knowledge and rules from the application source code, a conversion module for translating data from a legacy system to a new format, using Universal Application Notation (UAN), a deployment module for installing, configuring, updating, and enabling applications for use, including automated deployment of newly translated applications, and an integration module for seamlessly integrating new and legacy applications with a chatbot and/or low or no-code integration tools.

Some embodiments include a metadata linking system for tracking and linking the origin and identity of individual software components from extraction to deployment.

Some embodiments include a computer-implemented method for the integration and deployment of software applications, including extracting data and replicating it in a usable format, including business knowledge and rules from the application source code, translating data from a legacy system to a new format, using Universal Application Notation (UAN), deploying newly translated applications, including installing, configuring, and updating the applications for use, and integrating new and legacy applications with a chatbot and/or low or no-code integration tools.

Some embodiments include a computer-implemented method for managing the deployment of software applications, comprising receiving an application build request for a software application, extracting software source code for the software application from a source code repository in response to the application build request, performing automated security procedures to ensure the integrity of the software source code elements, combining the software source code elements into a requested baseline application build package in a secure build server, storing the requested baseline application build package into an application product depot, receiving a request to deploy at least one baseline application build package into a deployment environment, extracting a copy of the at least one baseline application build package from the application product depot, creating metadata to identify baseline application build packages to be installed into the destination deployment environment, associating the metadata with the destination deployment environment, installing the at least one baseline application build package and accompanying metadata into the deployment environment, and linking the metadata with the specific baseline product build installed into the deployment environment.

In some embodiments, the automated security procedures include virus scanning and code validation to ensure the software source code is free from malicious code and complies with coding standards. In some embodiments the application build request includes a specification of software components to be included in the baseline application build package and the method further comprises verifying that the software components meet the compatibility requirements of the software application. In some embodiments, wherein the requested baseline application build package is encrypted and decrypted by the secure build server using cryptographic techniques to ensure confidentiality of the software source code. In some embodiments, the destination deployment environment is a cloud-based infrastructure and the metadata includes parameters for configuring the deployment environment. In some embodiments, the metadata includes a change log for the software application, including a record of all modifications to the software application and the personnel responsible for making the modifications. In some embodiments, the metadata includes performance metrics for the software application in the deployment environment, including data on response times, processing speeds, and memory usage.

Some embodiments include generating an alert in response to a detected failure in the software application in the deployment environment and tracing the failure back to the software source code used in the baseline application build package. In some embodiments, the metadata includes a list of all supporting documents and tickets related to the baseline application build package.

In some embodiments, the software source code is versioned and the method further comprises identifying the version of the software source code used in the baseline application build package. In some embodiments, the destination deployment environment is a virtual machine and the method further comprises creating a snapshot of the virtual machine before installing the baseline application build package, such that the virtual machine can be rolled back to the snapshot in the event of a failure.

Some embodiments include a computer-implemented method for dynamically deploying software applications, including receiving a software file for deployment, retrieving parameters associated with the software file, configuring the software file for deployment based on the retrieved parameters, determining the type of file being deployed and the runtime environment in which the application will execute, performing any necessary additional operations based on the determined file type and runtime environment, deploying the software file programmatically using the configured parameters and operations, managing the software application as static content to reduce or eliminate manual operations during deployment.

In some embodiments, the retrieved parameters include the location of other files required for the software file to execute and the method further comprises retrieving the required files and configuring them for deployment.

In some embodiments, the retrieved parameters include the configuration settings of the runtime environment in which the software file will execute and the method further comprises configuring the runtime environment for the software file. In some embodiments, the additional operations include compiling the software file. In some embodiments, the determined file type is a business intelligence application and the necessary additional operations include configuring data sources. In some embodiments, the method further comprises automatically testing the deployed software file to verify its functionality. In some embodiments, the method further comprises generating an alert in response to a detected failure in the software file in the runtime environment. In some embodiments, the method further comprises automatically updating the software file in the runtime environment when a new version of the software file is available. In some embodiments, the runtime environment is a containerized environment and the method further comprises deploying the software file as a container. In some embodiments, the method further comprises generating usage data for the deployed software file, including data on the number of requests, response times, and errors.

### BRIEF DESCRIPTIONS OF THE FIGURES

Various exemplary embodiments of the systems and methods may be described in detail, with reference to the following figures, wherein:

FIG. 1 is a flowchart illustrating a method of dynamic software integration and/or automation in accordance with exemplary embodiments;

FIG. 2 is an illustration of a list of pre-existing connectors, according to various exemplary embodiments;

FIG. 3 is an illustration of a plurality of connected systems, according to various exemplary embodiments;

FIG. 4 is an illustration of a plurality of integrations, according to various exemplary embodiments;

FIGS. 5A-5E illustrate various steps of the creation of an integration between two services, according to various exemplary embodiments;

FIG. 6 is an illustration of mapped services, according to various example embodiments;

FIG. 7 is an illustration of a blockchain registry, according to various exemplary embodiments;

FIG. 8 is an illustration of transactions reporting between various systems, according to various example embodiments;

FIG. 9 is a diagram illustrating a general illustration of components of an information handling system;

FIG. 10 is a block diagram of an environment including an integration flow design tool, according to exemplary embodiments;

FIG. 11 is a diagram illustrating operation of integrated services according to various exemplary embodiments;

FIGS. 12A-12B are flowcharts describing a plurality of services performed as part of an integration process, according to various exemplary embodiments.

FIG. 13 is an illustration of a platform for software integration in accordance with example embodiments;

FIG. 14 is a functional block diagram of an example network architecture including an example artificial intelligence (AI)-based conversational querying (CQ) platform, according to exemplary embodiments;

FIG. 15 illustrates a cloud computing node, according to exemplary embodiments;

FIG. 16 illustrates a cloud computing environment, according to exemplary embodiments; and

FIG. 17 illustrates abstraction model layers according to exemplary embodiments.

FIG. 18 is a diagram illustrating how machine learning models connect with the extraction, conversion, and deployment services.

FIG. 19 is a flowchart illustrating the extraction, conversion, and deployment process of data from a legacy system or application to a new system or application.

### DETAILED DESCRIPTION OF EXEMPLARY EMBODIMENTS

These and other features and advantages are described in, or are apparent from, the following detailed description of various example embodiments.

Before the embodiments are to be explained in detail, it is to be understood that the presently disclosed subject matter is not limited in application or process to the details stated, as there are other embodiments and methods of carrying out and practicing the presently disclosed subject matter than those described. As such, the language used below is not limiting and states what may be used but may not necessarily be completely exhaustive.

Exemplary features and implementing technologies are disclosed below.
I. Migration
II. Extraction
III. Conversion and Universal Application Notation
IV. Deployment
V. Integration and Chatbox/bot Functions
VI. Other Exemplary Features

Information technology systems take a central role in the daily activities of most business operations. When an IT system becomes functionally old, businesses usually upgrade to a newer version or change to a different system completely.

Businesses may also decide to migrate their IT systems to a newer system due to business related decisions, potential M&As, new business verticals, and activities that require different IT functionalities. In order to implement applications from an existing IT system or platform, the desired applications are often converted or implemented to a new system.

Typically, conversions from an existing IT system or platform are executed manually into a newer system. Conversion from an old IT system to a new IT system may save time by utilizing the functionality of old assets with the new system. However, any resources saved by re-using the functionality of old assets may be outweighed by the expenses and extra time loss associated with the manual conversion and downtime during the time of change from the old IT system to the new IT system.

In addition, the conversion process from the old IT system or application to the new IT system or application may require comprehensive knowledge of the differences between the old system and the new system, or application or computer language and usually more expensive than a simple upgrade to a newer version of an existing IT system. This knowledge may also not be understood by anyone still working with the company. Along with the vast knowledge of both the new and old IT systems, a considerable amount of time is required to resolve the incompatibilities between the old and new IT systems while implementing the desired applications and data from the old IT system into the new IT system.

The process of transferring data from one system or application to another is known as migration. Migration is a complicated process made up of extraction of data in a legacy application, conversion of that data to a format useable on the new system, and deployment of the data to the new system or application.

Some embodiments aim to automate the migration of outdated computer programs, legacy systems, legacy applications, codes, and other applications into updated computer systems through a novel computer notation (called Universal application notation or UAN) as a medium repository and a low or no-code interface portal for the client on the front end to validate, edit and deploy to a target computer program. The embodiments should not be limited to a low/no-code interface, they may also include low-level or high-level code interfaces, GUIs, or any other interfaces.

Before migration can occur, lengthy assessments and cleaning of the source data must occur. This assessment and cleaning require parsing through the data and determining the parts of the data that are useable, important, and relevant. Manual migration can be more effective than automatic migration but requires an incredible amount of time, money, and effort to do correctly. The increased push for digitalization poses an additional challenge for firms that have an IT infrastructure that is not par with the current day standards of automation and efficiency in computer programs. The present invention helps to solve these problems by expanding upon automatic migration techniques.

Some embodiments are related to converting a computer code, a database, an application, or any other algorithmic process suitable for use on a source platform into use on a target platform. The method may comprise of analyzing source platform code; extracting information from the source platform code wherein the extracted information includes at least the logic, flow, user description in text or audio, and data of the source platform code, defining a structure, and storing the extracted information in a novel universal translation language in JSON format named Universal Application Notation (UAN), and transforming the extracted information into code suitable for the target platform wherein the transforming step comprises transforming information into code suitable for target platform after the extracted information is presented to the user on a no-code or low-code interface and their changes are recorded and performed during code transformation or deployment. Some embodiments may include a universal translation language similar to UAN in a format other than JSON. Herein, UAN is used as a placeholder for all universal translation languages or similar.

Exemplary embodiments bridge a gap between the organizational requirements to integrate the enterprise software without the cost and logistical issues of scheduling specialists each time a specific new enterprise product is purchased or requires changes in configuration and/or an error or adjustment in the configuration needs to be remediated, requiring the technical proficiencies that are otherwise required.

There is a significant amount of previous research about tools or methods of translating software-level languages to each other. However, there is a great difference between the programming concepts of different software level languages and no existent common language to facilitate an efficient translation, extraction, and deployment of the said computer languages and programs.

More executives are turning to robotic process automation (RPA) to eliminate tedious tasks, freeing corporate workers to focus on higher-value work. But RPA requires proper design, planning, and governance in order to boost business operations efficiently.

Universal Application Notation (UAN) allows for a universal format and acts as a central hub to increase the efficiency of extraction and deployment of a computer code. Applications can be converted to UAN, edited in UAN format, and then converted back to their source format or to another format entirely. UAN greatly reduces the complexity of application translation by serving as the hub in a hub-and-spoke model. For example, imagine we wanted to translate between 10 different languages. Without a universal language, each pair of languages would need a custom translation engine. This would be 90 permutations. The discrepancy grows exponentially as the number of languages grows. As another example, for 100 languages, there would need to be 9900 permutations, but with UAN only 200 would need to be built. This allows the inventive software to grow linearly with the number of connectors instead of quadratically.

Some embodiments are related to the extraction of converting code, configuration files, and/or Natural Language to UAN using technologies such as Process Mining, AI/ML/NLP for extraction, RPA Data, API integration, Language Parsers, and/or other processes.

The present invention may be equipped to extract different computer languages in different formats, however, storing the extracted requirements may only occur in UAN format or similar universal translation format.

An example use case would be absorbing code from a SaaS product, low code product, no-code product, mainframe system, API, Open-Source System, Database, Cloud IaaS, Integration Pipeline, ML Platform, etc., and then extracting out the requirements and storing them in a UAN format. The inventive software combines rules-based and ML-based algorithms to perform the extraction.

The present invention is also equipped to receive instructions from clients and programs in a variety of formats including low or no-code instructions. The extractor may also extract select parts of the software instructed by the client. Some embodiments may be equipped to extract security protocols, legal mandates, or business rules. Some embodiments may also be configured to create a visual map of related conditional statements of business rules which may later be edited by the user via user interface or low/no-code processes before being converted and deployed into the new system or application. Some embodiments may be related to providing a system for translating security objectives of software code.

I. Migration

The present invention is also equipped to receive instructions from clients and programs in a variety of formats including low or no-code instructions. The extractor may also extract select parts of the software instructed by the client. Some embodiments may be equipped to extract security protocols, legal mandates, or business rules. Some embodiments may also be configured to create a visual map of related conditional statements of business rules which may later be edited by the user via user interface or low/no-code processes before being converted and deployed into the new system or application. Some embodiments may be related to providing a system for translating security objectives of software code.

In some embodiments, the migration can occur via either “trickle” migration, which is moving portions of assets across systems, or “big bang” migration, which is a scheduled process that moves all of the data at once. It would be obvious to one of ordinary skill in the art to use the inventive software with any other current or future migration patterns. There are many risks involved when migrating large amounts of data. In a preferred embodiment, trickle migration, which is moving assets in smaller portions, is used for the safety and security of the data during migration. It also allows a company to not suffer a large downtime for the entire system. Trickle is more time-consuming than big bang migration but does not require the system to go down during the migration. Because trickle migration is done in steps, if an error occurs, that error can be easily located and fixed before redoing the step. Big bang migration is considered faster, but if an error occurs, there is no way to determine what portion of the system contains the error. This can have a large negative impact on the company because the system may have to be down for a considerable amount of time before the error is fixed.

II. Extraction

Extraction of data is obtaining data and replicating it in a way that is useable or readable. It takes the data from legacy applications and turns it into a meaningful script that can then be converted to the new applications. The present inventive software automatically extracts important information based on AI and ML processes.

Most companies hire companies or services to manually extract their existent IT infrastructure or legacy applications or data into a newer software, application, or any other algorithmic computer process. This can be a lengthy and expensive process. Also, traditionally, the transformation of the software applications involves studying the software application code and extracting business knowledge or rules from the application source code.

Rule extraction is the process of identifying the implementation of independent (business) logic that comprises the basic essence of applications. Such logic is normally characterized by a combination of conditional and imperative source code commands that affect a change in a business data entity. Conventional methods require a lot of manual effort and time for the transformation of the software applications. There exist solutions such as automating the transformation of the software applications to some extent. However, the process of extracting rules implemented by the existing solutions is time-consuming and computationally mundane.

Further, rules embedded in the application source code are often more complex than simple conditional statements. The application source code comprises tangled rule flows with a combination of rule constructs evolved over a period of time. Thus, the complexity involved in extracting and transforming the rules is very high resulting in missing many important rules embedded over a period of years/decades.

The software may be equipped to extract any kind of computer code or rule. Each time there is a new task that has not been completed before, the algorithm is trained to extract that specific software, code, or database, and store the method to complete that task to be used again.

In a preferred embodiment, the software contains different modules, called extractors, tailored to each system that is being extracted. For example, extraction from ServiceNow would use a ServiceNow extractor, and extraction from Salesforce would use a Salesforce extractor. These extractors each contain their own unique block of code. In another preferred embodiment, the software contains a library of helpful parsing and machine learning functions that can be leveraged by any extractor.

In some embodiments, The software may attempt to determine the type of code that it is looking at. When the software encounters code that it is unable to determine the type of, it will ask the user for the type of code it is looking at. Once the code type is determined, the software calls the appropriate extractor. The extractor will call the appropriate ML and parsing functions, as well as any custom logic housed inside of the extractor. The determination of which exact features an extractor will use are decided during development based on research into the functionality of the system the extractor is extracting from. Systems may include but are not limited to ServiceNow, Salesforce, or any other system of code including incomplete code and any current and future systems of code. The system may be written in any language, including but not limited to, low-level code such as mainframe code, high-level code such as Java, or natural language such as English or speech-to-text.

Some embodiments may be related to extracting incomplete software and completing the missing functions by using a recommendation algorithm trained on past use cases and edited by a bi-directional interface by the clients.

A method of completing an incomplete software program may include receiving high-level software code of a software program with multiple functions. The multiple functions may include at least one incomplete function and at least one complete function. The method may include using ML and past trained data to predict the missing functions. The method may also include using ML and past trained data to visually depict the predictions to complete functions and let the users edit the missing functions using a low or no-code interface.

In some embodiments, the software uses “fuzzy” extraction for the extraction of incomplete data. “Fuzzy” extraction means using machine learning (ML) and natural language processing (NLP) to extract details that would be inaccessible through parsing or rules-based methods alone. Sometimes a degree of estimation, inference, and intelligence is required for a full extraction of the data. In some embodiments, “fuzzy” extraction improves security and data integrity since it allows for a more complete extraction of the rules surrounding the security features and data integrity that may be incomplete and unusable in their original form. In a preferred embodiment, any requirements that are “fuzzy” extracted are flagged for users so they know to review and ensure they are in line with expectations. Users may also have the ability to manually update or change information or extracted data that is incorrect or inconsistent with their current system.

Some embodiments aim to automate the software generation process from either an existent software or from scratch with the ability to set up APIs, process mining, rules, artificial intelligence (AI), or machine learning (ML) based extraction. The automatic software extraction should not, however, be limited to these extraction processes, and intends to cover all automated extraction processes including all current and future processes. Using ML and AI, the software can sometimes infer the “big picture” from incomplete data. This is similar to “fuzzy” extraction. You can never truly with 100% accuracy get complete data from incomplete data, but ML can be used to estimate likely possibilities. Current leading-edge Natural Language parsers generally use some form of neural network. Some Natural Language parsers can run automatic or manual keyword searches, but they are less accurate. This is not meant to teach away keyword searches, they still have use in certain scenarios where ML is limited.

In a preferred embodiment, API extraction is primarily done with REST APIs because of the compatibility of JSON formatting with both REST and UAN. REST APIs are a more modern version of classic APIs that is widespread and easy to use. Extraction may occur via the parsing of data and/or with the use of web scraping tools. In another embodiment, SOAP, GraphQL, or other APIs may also be used for data extraction. Other APIs sold as a Software as a service (SaaS) may also be used.

In some embodiments, users will be able to merge and modify or slice and dice existing applications with low or no-code interfaces as well as manage various roles within the software to allow or limit certain functionalities and capabilities for users.

Some embodiments are related to a system and method for extracting a computer code, a database, or any other algorithmic process from a software, an application, or any other computer program for the purposes of translating to human-readable, and a low or no-code required interface for the purposes of editing, confirming and deploying the extracted abstract into another software, application or any other computer program.

Some embodiments may provide a method for extracting business rules embedded in an application source code. The method comprises a call structure of one or more programs present in the application source code by performing a control flow analysis on the application source code. The method further comprises recognizing, from one or more programs to one or more programs based on the call structure.

In another embodiment, static code analysis may be used to scan applications. Further, the data acquired by performing a static code analysis includes the data type and usage of the parameters associated with the rules, type of impact of a rule in which the parameters are used, and scope of the impact. The present software can scan applications without needing to run the application. This allows the software to perform static analysis instead of dynamic code analysis and allows time to be saved during the extraction. Dynamic code analysis may also be used but is not needed.

In one implementation, a system for extracting business rules may comprise a processor and a memory coupled to the processor for executing a plurality of modules comprising a creating module, a recognizing module, a grouping module, an identification module, and a mapping module. The creating module is configured to create a call structure of one or more programs present in the application source code by performing a control flow analysis on the application source code.

In preferred embodiments, data related to the extraction process is stored in a database. The data related to the extraction process may include schema definitions, processes, rules, API specs, workflows, etc. The use of a data warehouse to store operational data is not necessary but the capabilities to do so are possible with the inventive software or system.

Some embodiments may be equipped to extract client instructions via text and Natural language parsers to generate rules and directions for code transformation and deployment. Some embodiments may be equipped to extract such instructions by audio and use the same NLP methods to extract information from text documents or data.

Some embodiments may include a program for generating natural language rules (i.e., logic) by detecting, analyzing, extracting, and creating feature vectors from one or more code snippets. In an embodiment, this program may perform preprocessing techniques (e.g., removing reserved words (public, return, void, etc.), extracting contextual words, tokenizing data structures, retrieving and applying programmatic conventions, applying weights, etc.) on entire programs or smaller code snippets. In an embodiment, the program receives code snippets and associated metadata (associated files, functions, programmatic conventions, intermediate representation objects, etc.) from users of an application. In another embodiment, the program aggregates associated code snippets with applicable data stored in a database, thus creating code information.

Applicable data may be any information or metadata that is associated with a code snippet, such as historical rules, associated feature vectors, similar code snippets based in other programming languages, associated supporting files, and code complexity. In another embodiment, the program utilizes supervised training to train the cognitive model based on the aggregated information. In an embodiment, the program processes and extract code information from a code snippet (i.e., a snippet that does not have an attached or labeled rule). The program feeds the code information into a cognitive model (e.g., cognitive model) that can calculate and generate a natural language rule based on the code snippet. The program logs the code snippet, generated rule, and associated information (e.g., programming language, tokenized vectors, code comments, similar natural language rules, similar business rules, etc.) and stored it into a database.

In another embodiment, the program determines the programming language of the detected code snippet. In an embodiment, the program extracts the file extension from the parent source file to determine the programming language of the contained snippet. In yet another embodiment, the program extracts and analyzes the metadata associated with the snippet and the source file to determine the utilized programming language. In various embodiments, the program analyzes associated files contained within the workspace of the snippet to aid in determining a programming language. For example, if the program detects “.h” files within the workspace, folder or linked to the source file or snippet, then the program determines that the programming language utilized is either C, C++, or Objective-C.

In an embodiment, the program extracts code information from the snippet contents such as code lines, language conventions, and data structures (e.g., variables, arrays, lists, stacks, queues, heaps, matrices, etc.). In a further embodiment, additional code information includes but is not limited to, code complexity (e.g., amount of lines, imported modules, etc.), intermediate representation objects, identified programming language, related programming languages, and associated programmatic conventions.

The program then parses the extracted code information based on program-dependent parsers specific to the identified programming language. In an embodiment, the program removes system specific reserve words such as ‘public’, ‘return’, and ‘static’ in Java and ‘self’, ‘type’, and ‘write-only’ in COBOL. This removes numerous features that would not be useful nor descriptive when generating comments. In another embodiment, the program utilizes term (e.g., a word) frequency-inverse document frequency (tf-idf) techniques to calculate how important a term is to the comment. In another embodiment, the program utilizes tf-idf to calculate a series of numerical weights for the terms extracted from historical code snippets. In a further embodiment, the program utilizes said calculations to identify and weigh frequently used terms. For example, the program increases the weight of a word proportionally to the frequency the word appears in the code snippets and comments offset by the frequency of other code snippets and comments that contain the term. Some embodiments include a method where low tf-idf valued terms can be safely removed to decrease the number of features utilized. In another embodiment, the program removes punctuation (e.g., commas, periods, etc.) and reduces all letters to lowercase from code snippets, rules, and comments in order to reduce the number of dimensions. This allows the for the changing of format to JSON/UAN to be done more easily.

The program then tokenizes the code information after the extraction and preprocessing detailed above. The tokenization process may be programming language dependent, where different languages have different conventions that may impact the accuracy of the comment generation. This tokenization may allow the extraction software to easily convert the programming language into JSON or another format useable as a Universal Application Notation (UAN).

In this same embodiment, the program feeds code information into the cognitive model. The program may also feed the extracted word vectors and code information into a cognitive model. The cognitive model processes the extracted code information to evaluate the snippet. The cognitive model assesses the word vectors and code information by utilizing the training set of labelled snippet and rule pairs, to assign weights to the various components. Responsive to said training, the program can utilize the cognitive model, and the learned weights of the model, to generate a sequence of words that probabilistically represent a comment based on the snippet.

As the program trains the cognitive model, it extracts code information (e.g., word embedded vectors, etc.) from the code snippet and processes/vectorizes the extracted information. After the cognitive model is trained, the program feeds the extracted code information into the cognitive model, allowing the model to calculate and generate a natural language rule associated with the code snippet. The program may then log the code snippet and the generated natural language rule into the ML database for future training.

Some embodiments may include methods and systems for extracting functional semantics and isolated dataflow from imperative object-oriented languages. The method, in one aspect, may include identifying one or more methods and classes associated with one or more of a plurality of property labels in a computer code written in object-oriented language to extract functional and isolation characteristics in the computer code. The plurality of property labels may be supported by one or more checking rules. The method also may include applying one or more checking rules to verify that one or more methods identified with the plurality of property labels have isolation characteristics.

In one aspect, a system for extracting functional semantics and isolated dataflow from imperative object-oriented languages may include an object-oriented programming language module including at least a plurality of property labels for labeling functional and isolation characteristics of one or more methods and classes in a computer code.

III. Conversion And Universal Application Notation

Some embodiments are facilitated by a novel computer language named Universal Application Notation (UAN), intended to store extracted computer code. UAN is for storing application workflows, schemas, roles, APIs, security roles, security configurations, expressions, functions, methods, ML models, integrations, processes, RPA bot specifications, methods, files, folder structures, data, etc., and acts as a medium between countless computer languages that may act as an input code or deployment target.

UAN is a descriptive language in JSON format (though any other format could be used) used to neutrally describe an application, its workflows, its rules, and its databases. JSON is used because of its widespread use and compatibility with REST API.

JSON or JavaScript Object Notation is a standard text-based format developed from the JavaScript object syntax and used to portray structured data. JSON is an open standard format for creating and storing files or exchanging data that uses comprehensible and human-readable text made up of attributes and serializable values. JSON is a data format that is not dependent on any language. It is a data format used by several modern programming languages. JSON is used in electronic data exchange, such as transmitting data in web applications. Websites are made of web pages. These web pages display pre-stored information in a server and interact with the server using data formats such as JSON. Its ease of use and widespread use with object oriented languages makes JSON a perfect format for use with UAN.

UAN is stored in a containerized solution or within a series of microservices, which is either hosted in the cloud or hosted by clients on-premise. The “meaning” aka functionality is extracted from the code and stored in the UAN language. When transforming to a new code base, the semantics are converted into the appropriate syntax. A linguistic semantics model is not needed to convert data or code from one language or format to another. Instead, UAN is used as a type of data repository of application functionality.

Conversion is the translation of data from one format to another. In some embodiments, the inventive software would convert the source code and data to a UAN format to retain the viability and quality of the data and then convert the source code now in UAN into a format that is useable by a new system or application. Conversion of data usually requires comprehensive knowledge of data from the old and new systems. The inventive software allows users to have little to no information about the old or new system to start integration because of the extensive data extraction.

In other embodiments, a mechanism for the execution of rule merging is provided. Merging is the process wherein the rules that have the same business meaning are merged together for better maintenance and migration of rules. Merging of rules enables the user to merge rules within the rule set. The rule merging mechanism includes selecting a rule that is required to be considered for merging. With the help of a rich rule merging user interface, users are allowed to analyze and decide on the selection of a set of rules that needs to be merged. Upon selecting a rule, a searching procedure is implemented, wherein the searching procedure involves searching for the rule based on the variable's names used/modified by the corresponding rule set and based on the pattern of the conditional statements.

Further, based on the searching procedure, the selected rule is analyzed to identify one or more similar rules within the corresponding rule set for merging, wherein identification of similarity between the selected rule and the one or more similar rules is achieved through analysis based on the selected rule and the one or more rules associated with the corresponding rule set. The analysis for identification of similarity between the selected rule and one or more similar rules involves comparison of the conditional statements from the parent condition in the hierarchical structure of one or more conditional statements to the point till a match is obtained and grouping them based on number of levels matched. Each matched rule is grouped based on the number of levels of exact match. Rule merging enables to identify relevant conditions in the rules and merge them to single rules and remove duplicates. Rules identified for merging are made inactive and a new rule gets created up to the level of match and the traceability with the other rules are maintained.

Some embodiments may include a computer system that includes a processor and program storage coupled to the processor. The program storage stores a software instruction translator that, when executed by the processor, is configured to receive source code and translate the source code to a low-level language. The source code is restricted to a subset of a high-level language and the low-level language is a specialized instruction set. Each statement of the subset of the high-level language directly maps to an instruction of the low-level language.

The problems noted above are solved in large part by a computer system that includes a processor and program storage coupled to the processor. The program storage stores a software instruction translator that, when executed by the processor, is configured to receive source code and translate the source code to a low-level language. The source code is restricted to a subset of a high-level language and the low-level language is a specialized instruction set. Each statement of the subset of the high-level language directly maps to an instruction of the low-level language.

In other embodiments, a method includes receiving source code that is restricted to a subset of a high-level language and translating the source code to a low-level language. The low-level language is a specialized instruction set and each statement of the subset of the high-level language directly maps to an instruction of the low-level language.

Machine code is one of the few languages that can process directly without a previous transformation. Most programmers almost never write programs directly in machine code, because it requires attention to numerous details that a high-level language can handle automatically.

The machine code is a stream of raw, usually binary, data. A programmer coding in “machine code” normally codes instructions and data in a more readable form such as decimal, octal, or hexadecimal which is translated to internal format by a program called a loader or toggled into the computer's memory.

The system to be translated is typically in the form of a computer system operating software or in the form of a high-level computer code, a database, or any other logical process that can be incorporated into a wide variety of devices that provide different functionalities.

In exemplary embodiments, instructions for the integration of a plurality of services may be input by a user via low-code programming. Low-code programming is a visual development approach to application development. Low-code enables developers of varying experience levels to create applications for web and mobile, using drag-and-drop components and model-driven logic through a graphic user interface. The exemplary embodiments allow the use of low-code and/or no-code tools to provide the user with the ability to effect integration without the requirement for professional coding skills. In addition, exemplary embodiments include bot connecting technology that allows the platform to operate in concert with a variety of different bots that provide integration instructions to the platform of the exemplary embodiments. Accordingly, integration of a plurality of services may be performed both via input from a user or automatically based on the state of other services, as discussed above.

The exemplary embodiments enable switching between the bot technology and the low- or no-code programming so as to enable continuity of programming and integration efforts without regard to the system being used. To further advance their platform-agnostic nature, the exemplary embodiments allow compatibility with APIs of other commercially available chatbots, which provides the ability for the platform to work with a wide variety of different bots using the platforms bot connector technology that communicates events and actions for each bot. Such other commercially available chatbots may include products such as those based on Google Dialogflow, Amazon Lex, Microsoft Bot Framework (RASA), Samsung Bixby, etc. Example embodiments may also allow communication between different bots. In some embodiments, bots may be provided by third-party companies and integrated with the inventive system through the use of their APIs.

In some embodiments, the system may be configured to translate each computer language to one another, particularly by translating the code into UAN initially as a medium repository and later deploying it in the target language. The medium repository is the storage location for software or data packages in JSON. Other embodiments that include formats other than JSON are anticipated.

Writing software code in a specialized instruction set is arduous for programmers because they are required to learn both a new language and its associated syntax, Additionally, debugging software code written in a specialized instruction set may only be performed on machines that can compile the specialized instruction set, which may be inconvenient. However, high-level programming languages such as C may contain many statements that cannot be effectively compiled to the specialized instruction set for execution on an accelerator utilizing that specialized instruction set. Further, statements of a high-level programming language may map to tens or even hundreds of low-level instructions in the specialized instruction set, which reduces the efficiency of code generated for execution by the accelerator using a high-level programming language. Consequently, a programming language that is familiar to programmers, may be easily debugged, and maintains the efficiencies of a target specialized instruction set when being translated to the specialized instruction set is desirable.

The problems noted above are solved in large part by a computer system that includes a processor and program storage coupled to the processor. The program storage stores a software instruction translator that, when executed by the processor, is configured to receive source code, and translates the source code to UAN in JSON format. The source code is restricted to a subset of a high-level language and the low-level language is a specialized instruction set. Each statement of the subset of the high-level language directly maps to a medium repository language and can later be deployed in the target language. Migration and translation of low-level code such as mainframe code may be converted into a low or no-code platform or a high-level code such as Java. Natural language such as speech or natural language documents may also need to be converted to the new system or application.

It is generally easier to go from a structured language or format to a natural language than from a natural language to a structured one. The inventive software is sophisticated enough to convert UAN to natural language without the use of AI. AI is still used to convert natural language to UAN using NLP and ML models to structure the unstructured natural language.

Between the conversion of extracted files to UAN and the conversion of those files back into a format useable by the target systems, the UAN files may need to be modified to remove requirements from apps, merge applications, modify applications, etc. An application integrated development environment (IDE) may be used for editing UAN files and modifying applications. In a preferred embodiment, the Application IDE is An IDE No-Code portal for editing UAN files and modifying applications. The IDE can be used to remove requirements from Apps, merge applications, modify applications, etc. For example, a user could combine the data structure of one app with the workflow of another app, and then modify both of them by adding/removing data-columns and workflow-steps. This no-code IDE lets users without a background in computer science or application development modify their applications to fit their desired system. Other embodiments may include a low-code IDE or a high-level code IDE environment or platform to serve the same purpose.

In example embodiments, the IDE may be a software application that provides comprehensive facilities to computer programmers for software development. This no-code IDE allows for users without experience in software development to act as a developer without the need for extensive knowledge about computer programming. This IDE may be an already existing service or integrated service built for specific integration into the extraction, conversion, and deployment services provided above. This IDE may also be a version control system or a tool for simplifying the construction of graphical user interfaces (GUIs). In example embodiments, the Application IDE connects with the front end to provide a way to monitor, develop, and update the GUI and non-graphical user interfaces. The IDE may also provide tools to help with deploying software, debugging software, and software compliance.

In example embodiments, the IDE may connect with the storage API for connection of the locally based application to a database storage system. In some embodiments, this storage API may be a cloud-based storage API such as AWS S3, Google Cloud Storage API, Dropbox API, Adobe Creative Cloud API, or other current and future cloud-based APIs.

In some embodiments, these APIs may also run using REST, SOAP, or Java Database Connectivity request types such as GET, POST, PUT, and DELETE on a high-level code IDE. In example embodiments, software may be used to convert this high-level code to low code or no-code interfaces. A user may input natural language into a no-code interface such as a chat box and the natural language may be converted into high-level code or machine code request types useable with the application IDE connected to the storage API. Some embodiments include an application database to store data collected from the storage API.

In some embodiments, the conversion service collects the data from the extraction service through the storage API or from a file storage. The file storage contains the data extracted from the original application or system now in a UAN format. The file storage may consist of any file-level or file-based storage system as well as any method of storing files such as built-in storage systems, removable storage systems, network storage systems, online storage systems, cloud based storage systems, etc. Other embodiments may include other storage types such as block storage, object storage, etc.

In some embodiments, the application IDE may also connect to an analytics API to perform a systematic analysis of the data contained in the application. The analytics API may be used to find trends and patterns in the data stored in the application database. These patterns may include latency, error rates, cache performance, usage patterns, call spikes, etc. This data may be stored in a separate database for data analytics. Other embodiments may include a singe database for the storage of application data and data analytics.

Most companies hire companies or services to manually extract their existent IT infrastructure or legacy applications or data into a newer software, application, or any other algorithmic computer process. This can be a lengthy and expensive process. Also, traditionally, the transformation of the software applications involves studying the software application code and extracting business knowledge or rules from the application source code.

An existing object-oriented computer environment would include commercially available object-oriented languages such as Java, which is provided by Sun Microsystems Inc. Typical benefits of a commercially available object-oriented computer language include improved application extendibility, maintainability, data hiding and encapsulation which makes code reuse easier, and the ability to allow the user additional power and flexibility to implement complex applications. Further, if Java is selected, the automatic garbage collection feature and associated object reference counting design is particularly useful in certain languages, especially simulation language. Java's syntax is also based on C++ language syntax. Java's selection may also be appropriate if the legacy language is also based on C or C++ language syntax. The non-object oriented computer environment is identified.

In certain embodiments, The non-object oriented computer environment includes languages which implement structure other than the object-oriented methodology and are desired to be converted to an object oriented system. Thus, older existing languages which pre-date the use of object-oriented analysis and design are potential candidates for this conversion. Next, the requirements for the new object-oriented computer environment must be defined. A requirements document can be produced from a set of enhancement requests and an understanding of the non-object oriented computer environment. Further, basic requirements such as reusability would factor in the determination of defining the requirements. The requirements document can be used to identify any future functionality or improved functionality of the non-object oriented computer environment. Also, the requirements document can identify functionality present in the non-object oriented computer environment which will be advanced through the modification or conversion to the object-oriented computer environment. The grammar and syntax of the new object-oriented computer environment must be compatible with the non-object oriented computer environment. The compatibility is necessary as the non-object oriented computer environment language is to be extended to provide the new object-oriented capabilities. The beginning of the selection of the grammar and syntax occurs during the identification of an existing object-oriented computer environment. The existing object-oriented computer environment should be selected so that a standard object-oriented language specification is available and can be used as a reference document. Within this reference document, the use of the semantics of the reference language can be used as a guide to ensure that the functionality is implemented as part of the object-oriented conversion. Further, when the syntax or grammar is not exact, then the non-object oriented computer environment syntax should be followed as closely as possible to minimize the effort in determining the new object-oriented capabilities. Any language key words not present in both the existing object-oriented computer environment and the non-object oriented computer environment should be reserved for use in subsequent implementation. Next, the object-oriented extensions are developed. The object-oriented extension design should satisfy several goals. First, the object oriented computer environment should not burden the legacy system user in cases where the new OO functionality is not used. The interface to the new OO features should appear natural and easy to learn for the legacy system user. Second, the object oriented features of the new object oriented computer environment should be able to access the non-object oriented computer environment information so that existing applications can take full advantage of the new object oriented functionality. The non-object oriented computer environment application integrity should be preserved through the internal creation and management of key structures including structures as processes, threads and/or messages.

In one embodiment, to preserve the integrity of the legacy system while giving the user more control, an object implementation was designed to include a header structure and a data structure. The object header structure was defined for use by all objects in the design. The mapping of all user-defined information is made to secondary structure. The object header points to either a user defined structure or a non-object oriented computer environment data structure. By this approach, the non-object oriented computer environment information can be accessed in the same way as other object-oriented information. Second the object reference type was added to the semantics of the non-object oriented computer environment generic variable so that it was able to access any type of information in the new object-oriented computer environment. Next, the general purpose utility classes were developed. No general purpose utility classes existed in the non-object oriented computer environment. Therefore, to drive the full functionality of object-oriented operations, the general purpose utility classes must be added. Next, the new object-oriented computer environment is prepared. In preparing the new object-oriented computer environment, the requirements defined, the grammar and syntax selected, and object-oriented extensions must be considered to implement and develop the new object-oriented computer environment to accomplish the goals of completeness and ease of use. Any of various common code generation techniques are usable and their use does not detract from the spirit of the invention.

IV. Deployment

Deployment is installing, configuring, updating, and enabling applications to make the software system available for use. It also entails delivering software from developers to users. Deployment is the last step of migration and may include testing of the updated system and or application for bugs or security issues.

In an embodiment, a deployment system is provided. The system comprises at least one computer system and a deployment application that, when executed on the computer system, extracts software source code from a source code repository in response to an application build request. The system also inserts the software source code using an automated process into a secure build process to produce software baseline code, places the software baseline code into an application product depot, and extracts a copy of the software baseline code from the application product depot in response to a deployment request. The system also creates metadata to associate a destination deployment environment with the copy of the software baseline code deployed into the destination deployment environment and installs the copy of the software baseline code into the destination deployment environment, wherein the automated baseline deployment application prevents the insertion of source software code from sources outside the source code repository into the secure build process.

In another embodiment, a method of building a baseline software application using a deployment application is provided. The method comprises receiving a message containing an application build request, starting a secure software build session between a source code repository and a designated build server, and extracting copies of source software code elements from the source code repository. The method also comprises performing automated security procedures to assure integrity of the source software code elements moving from the source code repository and inserted into a build process on the designated build server, combining the source software code elements into the requested baseline application build package in a secure build server, and storing the requested baseline application build package into an application product depot.

In another embodiment, a method of deploying baseline application build packages into deployment environments is provided. The method comprises receiving a request to deploy at least one baseline application build package into a deployment environment, extracting a copy of the at least one baseline application build package from the application product depot, and creating metadata identifying baseline application build packages to be installed into the destination deployment environment. The method also comprises associating the metadata with destination deployment environment and deploying the at least one baseline application build package and accompanying metadata into the deployment environment. The metadata promotes identifying at least one of the destination deployment environments, the build numbers of baseline application build packages deployed, the deployment methods used, the identifications of personnel requesting and authorizing deployment, and the locations of supporting documentation. In an embodiment, the metadata links the destination deployment environment with the at least one baseline application build package deployed into the destination deployment environment.

Several embodiments of a deployment system enable the development and deployment of a software application to be traced from its genesis as a collection of component software code elements through tightly disciplined baseline build and installation processes with the origin and identity of the individual base software components remaining traceable and identifiable. The system isolates, identifies, and traces the development and build processes of software components in applications that fail or perform below expectations in production or test environments. Software components may be further isolated and analyzed with the support of documentation that accompanies each baseline build. The traceability of base software code elements from their deployment destinations in applications in production or test environments back to their baseline build and further back to their original development source along with the control provided by the system at each step permits more rapid isolation, identification, and correction of failing or underperforming software components.

The automated baseline deployment system may be distributed across a plurality of servers and networks in separate build and deployment environments as a suite of networked applications. The functionality of the system is spread across system components comprising source code repositories, application build servers, application product depots, and deployment environments. While separate components or subsidiary applications within the system may perform the build and deployment tasks of the system, the system also enforces the integrity of the software components and their supporting tasks, tickets, and other documentation that combine in the build process to create a product baseline. The automated baseline deployment system thereafter in the deployment process tracks product baselines by identifying their specific builds with the destination deployment server, servers, network, or broader environment in which the products from a particular baseline build are being installed. Metadata describing a destination deployment environment is linked with the specific baseline product build installed into the deployment environment. The metadata permanently associates a specific baseline product build with a specific server or group of servers in which the baseline software product is installed. The association in the metadata of the baseline product build used with the specific destination deployment servers allows problems in a deployed software application to be traced back to the baseline build wherein the individual software components in the baseline build may be examined in conjunction with the supporting tasks, tickets, and other documentation used in creating the baseline. The security of the baseline build process and the linking by the metadata of specific baseline builds to the specific deployment servers into which the baseline builds are installed provides the continuous integrity needed in enterprise software build and deployment environments.

The deployment of a dynamic application may need to set customized parameters for the application. For example, the application may or may not have dependencies to other designated files, may need access to selected databases, and/or may need other types of settings to be configured in order to ensure proper execution of the application. Additionally, different parameters may be set and/or different operations may be performed in order to configure an application for deployment depending on the type of environment it is to execute on. For example, an application may be deployed differently for a quality assurance environment than for a production environment. Applications of different types are handled differently from one another. For example, a J2EE application will typically involve different parameters and different deployment operations to be performed than for a business intelligence application such as forms files and reports files, or a CGI script file, and other file types. Some file types need to be compiled before deployment.

Due to the dynamic nature of applications and their deployment, the deployment process has traditionally relied on manual operations performed by an experienced operator. In one example, a software developer who desires to deploy a file would upload the file to a server and submit a service request to a deployment operator to deploy the file. The deployment operator would retrieve the file and prepare the file for deployment based on, for example, selected parameters, special instructions, or other types of settings that may be requested by the software developer. Other parameters and operations may also need to be performed based on the type of file being deployed and the run-time environment in which the application will execute in. The deployment process is typically time consuming and tedious, and is susceptible to operator errors. Furthermore, once an application is deployed, correction of errors and product enhancements generally mean the application will continually be re-deployed and go through the deployment process numerous times.

With the example systems, methods, and other embodiments of the deployment logic described herein, a computer system can have the ability to manage different file types and programmatically deploy the different file types. In this manner, a dynamic application can be treated as static content while reducing or even eliminating manual operations performed during a deployment process.

The present software can deploy software to wherever the client wants it and is not limited to specific systems or cloud environments provided it is granted the appropriate access. Users also have the ability to deploy fractions of systems or applications such as single workflows, rules, schemas, etc., or any combination of partial applications or systems.

In one embodiment, there is a method that receives multiple inputs from application source code components associated with software applications. A control flow or data flow analysis is conducted and important information is extracted from the application source code. Rules that were extracted from the application source code can be translated into a target-defined format (in this case UAN or any other universal translation notation) based on mapping the parameters associated with the rules into one or more categories. The rules in the new format are analyzed for compliance and errors using AI, ML, and pre-stored metadata.

In an embodiment, the step of classifying the mapped parameters into categories is utilized to derive relevant information from the parameters associated with the extracted set of rules. In an embodiment, the relevant information for the parameters is derived using data acquired by performing static code analysis on the received inputs. Further, the data acquired by performing a static code analysis includes the data type and usage of the parameters associated with the rules, type of impact of a rule in which the parameters are used, and scope of the impact. In an embodiment, the step of translating is preceded by performing at least one of (i) a merging mechanism or (ii) a splitting mechanism on the extracted set of rules.

In some embodiments, the system may be equipped to receive multiple inputs from the application code components. The inputs may include source codes, configuration files, logs, raw data, files, etc., pertaining to software applications. Further, the plurality of inputs from application code components are parsed and analyzed to extract the rules and important code present in the system based on its control flow and data flow.

After extraction of all rules present in the system, technical rule(s) are identified and eliminated. Based on the requirements, a simultaneous mechanism for splitting and merging the extracted possible rules can be executed in accordance with the user's manual edits through the user interface. Further, extracted possible rules are translated with appropriate descriptions into a target-defined format (such as UAN or other universal translation formats). The translated rules are further analyzed to obtain a validated set of rules which are used for deployment in the updated application or system.

In some embodiments, the system may also be equipped with one or more hardware processors that are configured to receive inputs from the application source code components associated with the software applications. In another embodiment, the inputs may include one or more source codes pertaining to each software application. The inputs are received using a parser module from a plurality of data sources. The parser module is used as a user interface between software applications and external users and provides an understandable structure format of the received plurality of inputs. This parser module may be activated using low/no-code interfaces such as graphical, “chat-box”, or other interfaces. Other current and future interfaces may also be used. The deployment service can be set up to be a drag-and-drop/low-code user interface. This may include a method of GUI implementation for the deployment system.

In some embodiments, hardware processors may be configured to extract a set of rules embedded in the application source codes based on a control flow and data flow analysis used by the software applications. In an embodiment, the control and data flow analysis generates a hierarchical call structure of one or more programs present in the application source code of the software applications. In another embodiment, the control flow and data flow analysis determine a control flow and data flow between the programs and are expressed as a control flow and data flow graph. The control flow and data flow analysis could be performed using techniques comprising abstract representation, resolving dynamic calls, object resolutions, and control transfers, but should not be limited to these.

The system may be configured so that the entry point component(s) for the software application are identified and grouped with corresponding one or more child programs components providing a plurality of grouped components. Each program in a group may include a plurality of conditional statements. In an embodiment, the parent component and the one or more child components are identified based on the hierarchical call structure generated by an analysis based on the control flow and data flow, wherein the parent program is capable of calling the one or more child programs. As inherent in the field of software applications, all software applications comprise program components. In software platforms, every online transactions and batch jobs invokes a parent or an entry point program component and the system first captures this information from the available application source inventory. In an embodiment, the hierarchical call structure is generated from the parent component or entry point component, by including each of the one or more child programs also known as programs in the control flow and data flow.

For example, if a Program A calls Program B and Program C then Programs A, B and C generate a hierarchical call structure based on a control flow and data flow, then Program A is identified as the parent or an entry point program which is capable of controlling one or more child programs (in this case Program B and Program C). The components in the hierarchical call structure are grouped and associated with the parent or entry point component. The number of parent components or entry point components determine the number of groups that gets formed for a given application. All the further process steps are performed independently in each such logical groups.

Further, the extraction process may include traversing forward through the control and data flow till the end of either the control flow or the data flow. While traversing forward through the control flow and the data flow, a status of the control or data flow is determined in the hierarchical call structure(s) of one or more programs associated with identified parent program component(s) or entry point component. Here, the status corresponds to end or no end of control or data flow. Further, one or more hardware processors may be configured to identify one or more conditional statements among the plurality of group components. In an embodiment, the one or more conditional statements generate rules, wherein the generated rules are identified by (i) generating one or more hierarchical structure of conditional statements based on a control flow analysis and (ii) performing a data flow-based analysis in the hierarchical structure of conditional statements. The hierarchical structure defines parent or entry conditional statements and child conditional statements dependent on the parent or entry conditional statements. In traditional systems and method, the conditional statements and rules are identified based on a pattern-based grouping and elimination process.

Despite the availability of the above-discussed applications, a high degree of technical expertise remains required to provide software integration and automation of disparate enterprise systems. Integration can be understood as the coupling of two or more connected systems to allow the flow of data and other information between the two connected systems.

Some embodiments include system-agnostic technologies allowing incorporation of application programming interfaces (APIs) from multiple applications as well as integration of APIs from other applications that can assist in the integrations (bot, other low/no-code technologies, data visualization, ticketing, and others). Other exemplary embodiments include the use of block chain technology to enhance integration record keeping on an application and macro integration level as well as event and performance recording and other advantages.

In some embodiments, advantages of using a blockchain to store integration and update information include decentralization, where with the digital ledger that is blockchain, transactions can occur quickly and securely anywhere in the world. Transactions can be completed across the world, and because the blockchain cannot be tampered with, and because it is a direct A to B relationship to make the transaction, there is a level of trust that would not be otherwise available without some third-party or central authority verifying that trust. Accordingly, no broker or notary may be necessary to ensure that the transaction takes place as intended. Another advantage of blockchain is cost-saving, as intermediaries such as trust verifiers are no longer necessary. Another advantage of blockchain is the reduction of fraud and traceability of transactions and the documents involved. Because blockchain records are literally a chain, it is easy to trace a transaction block by block between parties to a transaction.

Additional advantages and novel features of these exemplary embodiments may be set forth in part in the description that follows, and in part may become more apparent to those skilled in the art upon examination of the following or upon learning by practice of the invention.

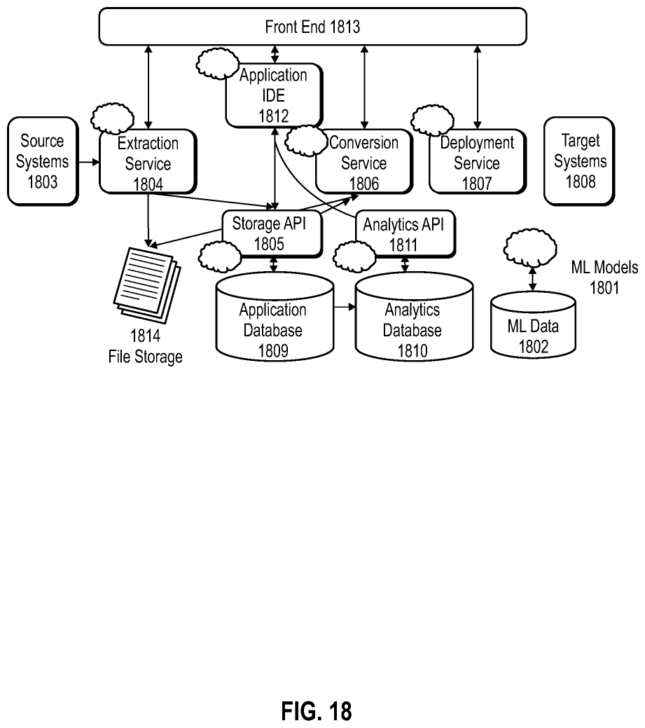

FIG. 18 is a diagram illustrating how machine learning models connect with the extraction, conversion, and deployment services. Source Systems 1803 are extracted and converted to UAN at the Extraction Service 1804. The Source Systems 1803, now in UAN are sent to File Storage 1814 and Storage API 1805 for later use. The Conversion Service 1806 can access the Source Systems 1803, now in UAN from the File Storage 1814 or the Storage API 1805. The Conversion Service 1806 converts the Source Systems 1803, now in UAN, into a format useable in the Target Systems 1808 and sends it to the Deployment Service 1807. The Deployment Service 1807 deploys the data, now in the target format to the Target Systems 1808.

Application data is sent to and from the Storage API and the Application IDE 1812. At the Application IDE, users have the option to remove requirements from apps, merge applications, modify applications, etc. The Storage API 1805 also sends the data to the Application Database 1809 for storage. The data can be moved from the Application Database to the Analytics Database 1810 for storage. User feedback and analytics data are constantly being gathered to improve the ML Models 1801. This information, and the information stored in the Application Database 1809 may flow freely between the Analytics API 1811 and the Analytics Database 1810. The information from Analytics API is sent to the Application IDE 1812.

The ML models 1801 are trained and used by the Extraction Service 1804, Storage API 1805, Conversion Service 1806, Deployment Service 1807, Analytics API 1811, and Application IDE 1812. The ML Models 1801 and the trained information are stored in an ML Database 1802. The information from the Extraction Service 1804, Application IDE 1812, Conversion Service 1806, and Deployment Service 1807 may be sent to the Front End 1813 at any time where a user or developer may access the information in different formats and change or update the information pertaining to the Source Systems 1018 or applications contained in the Source Systems 1803.

Some embodiments include Machine Learning (ML) models that involve providing an ML algorithm or learning algorithm with training data. This training data may include targets or target attributes that contain pattern information to be mapped back to inputs performed by the ML model algorithm. This provides the ML model with information pertaining to a “correct answer” that it can use to predict “answers” to real-world scenarios. In this case, the algorithm is used to Extract, convert, and deploy data from a source application or system to a target application or system.

The ML models in some embodiments may be used in the extraction of information and conversion of information to UAN. These ML models are trained to convert natural language, High-level code, low-level machine code, low or no-code data, etc. to UAN in a JSON format. These models take important information from the source application or system and convert it to JSON to be stored in file storage or sent to the Storage API.

Other embodiments may include ML models that parse source applications and systems for incomplete or incorrect data that is then completed or corrected with the help of AI algorithms. This now complete and correct data can then be converted to UAN for storage in file storage or sent to the Storage API to store in the application database.

Some embodiments may use ML to convert UAN into a useable format for new systems and applications that run using newer software. These models are used in the conversion service and are trained to translate UAN/JSON format into any language needed by users or developers. Other embodiments may include a universal notation in another format than JSON such as XML, CSV, RSS, YAML, Protobuf, Avro, MongoDB, and OData. One of ordinary skill in the art would understand that it would be possible to use UAN to convert JSON format into one of these other formats as well. Use cases of other formats may include when a developer needs namespace support to support objects with different names, or when data is needed to be encrypted for high security purposes. JSON is used because of its capability to interact with REST API and because it is a format easily read by both humans and machines.

Some embodiments may also include ML models used with the storage API and analytics API. These AI/ML APIs integrate both AI and ML techniques to obtain relevant data and access server software or other applications. These AI/ML APIs also give a clean and well-defined interface to use with analytics. They can be easily integrated with any application using a client URL command. AI/ML APIs also provide webpages with stable access to databases housing internal information or internal analytics servers. AI/ML APIs also provide added security because the algorithms used only accept requests from known and secure locations. Requests are only allowed if they are signed with a token that holds the right permissions. This may ensure a higher level of data integrity. These APIs are trained using ML algorithms which allow for the reusability of the APIs. Multiple application may use the API without the need for additional software and settings. Once the API is deployed it can be queried immediately. In certain embodiments, the use of non-AI/ML APIs would also be possible.

The storage API collects application data and JSON files from the extraction service and connects this data with the application database. It may also collect user/developer inputs, changes, and updates from the application IDE. It may also allow users/developers to access, add, update, and delete data from the application database.

The analytics API uses ML to look for patterns in the application data. These patterns may include latency, error rates, cache performance, usage patterns, call spikes, etc. that are important for the developers of the application to understand. The information and patterns collected by the analytics API are stored in the analytics Database. Users may use the Application IDE to access this data from the front end.

In a preferred embodiment, the storage API and analytics API are one of a partner API or internal API. A system including the use of partner APIs allow a customer-to-business relationship to occur and allow the share of data to be simplified between the company owning the system or application being migrated and the company migrating the data. This allows for the user to modify their system and application without the need of help from the company migrating the data.

Internal APIs may also be used when there is no need for the company who owns the system or application being migrated to have access to the API or database information. Certain customers may want the migration of their system or application to occur quickly and reliably. Internal APIs would allow for the extraction, conversion, and deployment of the original data to the target system by professionals.

In some embodiments, The storage API and analytics API may form a composite API to bundle calls or requests. This allows for a single unified response to be created from multiple servers. These APIs may also be open APIs. Open APIs may also be used when dealing with an opensource project. This may allow for a project to be completed faster with lower cost. They should be used when encryption and security of data is not a concern.

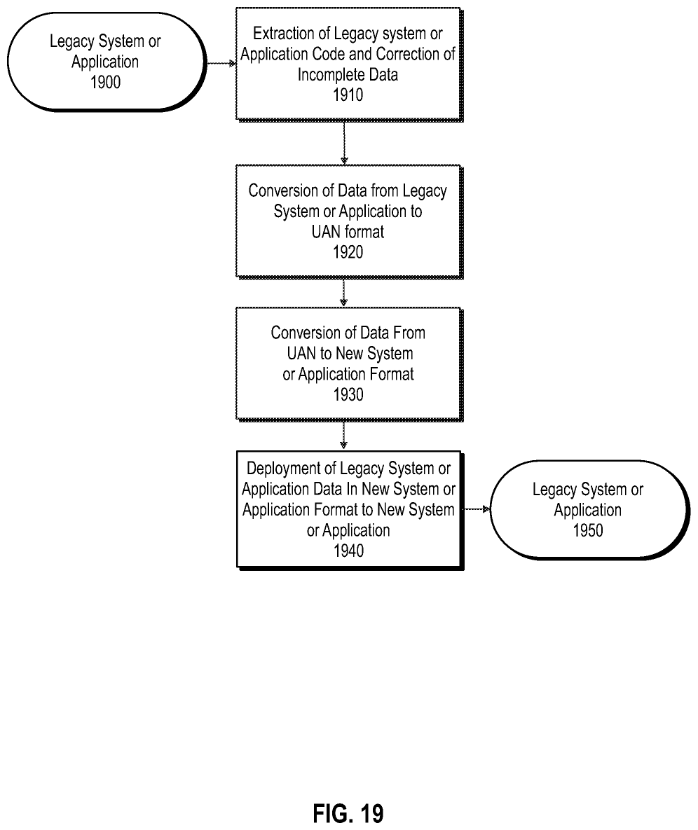

FIG. 19 is a flowchart illustrating the extraction, conversion, and deployment process of data from a legacy system or application to a new system or application. These steps include extracting 1910 code or data from the Legacy System or Application 1900, Converting 1920 this data to a UAN format, Converting 1930 the data, now in UAN, into a format useable by the New system or Application 1950, and Deploying 1940 the data, now in the format useable by the New System or Application 1950, into the New System or Application 1950.

Other embodiments may include a mixture of steps 1920 and 1930 without the use of UAN. This process may include extracting data from a legacy system or application in one format, converting that code into a format usable by the new application, and deploying the code into the new system or application using a single process.

V. Integration and Chatbox/bot Functions

In exemplary embodiments, the method monitors the integration of all the services being integrated, or that are part of the integration. For example, the sending of an email or instructions received via a chat box may be the event that initiates an integration, while the very same email or chat box entry may be a result of the action of another integration. In exemplary embodiments, both these integrations are being monitored to determine whether the integration has been properly launched, performed, or terminated and whether data can flow freely from one connected software system to another.

In exemplary embodiments, monitoring of integration being performed includes using different database structures, including cloud and/or on-premise options. For example, individual enterprise solutions may use a variety of databases that the platform can access during the integration of the various services. In exemplary embodiments, the platform may use a variety of different database options that provide dynamic tracking and integration history storage and retrieval such as, e.g., AWS Dynamo, Blockchain, S3, Serverless RDS, etc. Other state-based dynamic systems such as graph-database Moogsoft may also be used in the exemplary embodiments.

In exemplary embodiments, the method determines, at a platform level, whether one of the connected software systems being integrated has been updated, removed, or altered, or whether a new software system has been integrated to the already connected software systems. In exemplary embodiments, if none of the connected software systems are removed, updated or otherwise changed, or if no new software systems have been connected to the already connected software systems, the method returns to where the platform continues monitoring the integrated software systems.

In some embodiments, the platform may be equipped to determine that one or more of the connected software systems has been removed, updated or otherwise changed, or that one or more new software system has been connected to the already connected software systems.

The platform may also be equipped to determine which other ones of the connected software systems, if any, have to be updated, altered or removed, or whether a new software system needs to be added to the integration platform, as a result of the determination that one or more of the connected software systems has been removed, updated or otherwise changed, or that one or more new software system has been added to the integrated software systems.

In some embodiments, the method performs necessary updates on any software system that may be updated or otherwise altered or changed as a result of the determination that one or more of the connected software systems has been removed, updated or otherwise changed, or that one or more new software system has been added to the integrated software systems.

The system may periodically check connected systems for improper edits, and automatically correct utilizing trained ML models for converting the input system to target system. In exemplary embodiments, the user may configure for notifications to be sent upon the identification of bad data and/or to not autocorrect issues if needed. In exemplary embodiments, transactions may also be stored in a blockchain ledger or registry for data integrity. In exemplary embodiments, the blockchain registry lists the transactions that are or have been logged for each block.

Some embodiments include a code base that is configured to offer persistent monitoring of each, or of one or more. Exemplary embodiments also provide the ability to dynamically adapt and recommend changes that may be needed when one change is made in the system and others need to be made to accommodate the change so as to maintain data continuity. The code base may exist both in the cloud as well as residing on premises for software that is deployed internally within companies. Supplement existing services with a layer of custom code is provided to enable fine-tuned integration specific functionality. For example, using a platform according to exemplary embodiments for integrating with a ticketing system like ServiceNow, the platform may implement “smart” integration to automatically update workflows inside of ServiceNow, or change the service-level agreements (SLAs) for ticket due dates, or update the email settings of the system. Accordingly, a greater degree of intelligent orchestration capabilities may be afforded.

In exemplary embodiments, the platform is configured to effectuate macro changes and rapidly reconfigure integrated services by making use of a new logic, derived from detected updates in one or more of the services, and this new logic may become embedded in each of the integrations so as to have, e.g., built-in parameters and relationships, or a taxonomy of integrations. Accordingly, changes or additions to various services may be logically implemented with greater coordination, and issues that may occur if each integration was merely changed or updated individually from the rest of the services, without the coordination afforded by the exemplary embodiments may be avoided. In exemplary embodiments, an application code may be injected throughout each integration, the application code taking into account and managing some or all of the systems on the platform, and coordinating the integration of some or all of the systems, thus ensuring a seamless integration of all the systems on the platform. Thus, the exemplary embodiments afford the ability to configure and develop connected applications or systems, whether open source or proprietary, instead of merely integrating them. As a result, the platform according to exemplary embodiments provide the ability to make platform changes inside of the connected systems, which may enable an end-user to move beyond simple integration and to perform deeper, programmatic integrations. For example, such programmatic integrations may include building a ServiceNow Application inside of a connected ServiceNow instance using the conversational platform offered by this invention.

In exemplary embodiments, to add additional capabilities of the method, a platform configured to implement the method may provide an API and can be integrated with tools that facilitate enterprise integration (such as Salesforce, IBCO, Boomi, Informatica, Talend, Adeptia, Cleo, Axway, Jitterbit, Spring, Amazon Web Services (AWS)). In addition, the system can be integrated with systems that provide additional enterprise IT management capabilities such as Moogsoft as well as virtual machine software and on-premise management software packages.

Exemplary embodiments can make use of menu-based bots (also known as chatbots), where users select a path based on a menu of options that the bot delivers to the end user. The platform according to exemplary embodiments exposes connected enterprise systems as Bots. The Bots expose connected systems as bots where users can perform actions such as adding a new service, removing an existing service or altering an existing service through the use of speech. NLP Bots, which rely on natural language processing to interpret free text and make use of intent and entity extraction, interpretation and mapping to functional actions involving software integration. In the case of NLP bots, a user may ask natural language questions in a dialog box, i.e., to a virtual developer, and an answer may be provided back to the user based on information available in the integrated systems. If more specifics are required to formulate the answer, the user may be prompted for clarifications. Such mapping can be further informed and refined by both manual input and refinements to machine learning systems coupled with rules-based algorithms that define software specific systems as well as general logic that is generically applicable to a wider range of software systems.

In some embodiments, AI bots may learn from past usage as well as feedback from the system (including violation notices, analytics, measures of data integrity) to recommend specific conversion or extraction options that will satisfy the need for client with respect to its security and software application goals.

In exemplary embodiments, the platform may also refine its machine language (ML) models through the use of aggregate integration data coupled with curated outcomes data (such as self-reported feedback of the integration, sentiment analysis (both automated and/or manual) of bot correspondence and objective measures of integration efficacy such as results of log-files, data validation, and any violation or help desk issues that occur after an integration). These machine learning models will be paired with rules-based systems when appropriate to create ensemble models with greater accuracy. Integration with tools such as ServiceNow which is a ticketing tool that processes and catalogs customer service requests, providing reporting data on incidents, changes, problems, and other services using tools like ServiceNow.

ServiceNow is a task management platform. It uses tickets, which are requests logged on a work tracking system detailing an issue that needs to be addressed or tasks that need to be performed. It also tracks incidents and requests to learn how to fix problems that have been seen before faster. It sends information to people that need it with automatic communication. It is also useful for triage or assignment of urgent tasks to the correct people at the right times. Because it is a platform built in the cloud, it does not need to be installed locally on machines. Applications can be built on top of or integrated within ServiceNow.

ServiceNow integration can enable quantitative and qualitative feedback from ServiceNow and other ticketing and integration services. Integration can be understood as the coupling of two or more connected systems or the addition of a new service, removal of an existing service or alteration of an existing service,

In exemplary embodiments, when one of the connected systems is integrated into another, other systems may be automatically and dynamically updated to ensure that all the systems remain integrated together, and to avoid errors in file transmission or in integration due to, e.g., the update of one system rendering the system incompatible with another system.

An example of the creation of an integration or process automation may be facilitated via a chatbot. In exemplary embodiments, integration encompasses integrating software systems that were not previously integrated, addition of a new service to integrated software systems, removing an existing integrated software system, or altering an existing integrated software system.

The user may not need to enter that exact command, as the NLP algorithms can interpret the meaning of natural language. For example, a user may say “I want to create a process automation”, or “let's make an integration”, or “I want to automatically integrate ServiceNow with Jira”, etc. In these examples, the system may still understand that the user wants to create an integration and begin the creation process. In response, the system according to various exemplary embodiments enters into an interactive exchange to identify which origin service to integrate. In the illustrated example, the origin system is identified as “ServiceNow.” The integration of files from ServiceNow to allow documents to flow from ServiceNow to another service, in this case Google Cloud Storage. In exemplary embodiments, the system request entry of one or more target services. When the target service is entered in chat box, in exemplary embodiments, the method may request clarification of whether the integration is unidirectional of bidirectional in chat box. Unidirectional integration is when integration is from only one service to another. For example, unidirectional integration of documents from ServiceNow to Google Cloud Storage is the integration of documents only from ServiceNow to Google Cloud Storage but not from Google Cloud Storage to ServiceNow. Bidirectional integration between ServiceNow and Google Cloud Storage allows the flow of documents from ServiceNow to Google Cloud Storage as well as from Google Cloud Storage to ServiceNow. In exemplary embodiments, the directionality of the integration can be entered in the chat box. In exemplary embodiments, the method may also request entry of the frequency of integration, e.g., real-time, hourly, or daily, in the chat box.

In exemplary embodiments, although the above integration parameters are entered in a piecemeal fashion by successive prompts, the entire integration parameters may be entered in one continuous line of natural language instruction.

In exemplary embodiments, the system may also provide the capability of further escalation to a consultative human-based developer to resolve integration challenges. To further the ability to offer bi-directional exchange between the end-user and the platform according to exemplary embodiments, the system also offers dynamic question-answer (QA) regarding the integration process and integration status, as well as validation and violations and other integration metrics. This dynamic QA leverages machine learning models trained on aggregate user behavior to answer frequent user queries. As violations and errors occur, the system may report to end-users, notify them through email with recommendations for fixes, and attempt to automatically correct the issue when appropriate. Users may be able to enable or disable any of these violation features. This dynamic QA can make use of the Integration Platform as a Service (IPaaS) and other standards for dynamically recording system status and integrations such as IT service management (ITSM) and others.

The platform according to exemplary embodiments can also provide higher accuracy of the NLP by enabling the ability to transverse a taxonomy of vocabulary associated with integration tasks at different levels or steps of the integration as well as consideration of different enterprise software packages.

In exemplary embodiments, if the intent and/or entit(ies) cannot be determined from instructions entered by a user, the NLP can suggest the closest matches from a library, or enable manual low- or no-coding. This step can also occur during an integration if/when the system or the end-user determines that it is useful to switch modality from NLP to low or no code. In exemplary embodiments, a low-code wizard may be available for record creation. Both the core chatbot and the low code wizard are synchronized with respect to user inputs so that a user can start a process through one and finish through another. In addition, while not preferred, a simple excel-like language of functions can be used when complex mappings are required such as string substitutions or aggregations. In exemplary embodiments, low code is a visual approach to software development which abstracts and automates every step of the application lifecycle to enable rapid delivery of a variety of software solutions. For example, a low code approach allows developers to drag and drop application components, connect thein together and create, e.g., an application.

In exemplary embodiments, NLP is coupled with Chatbot technology to enable text and/or voice based interaction with the system. Many traditional enterprise platforms offer the ability to switch between low code and traditional coding views. This instead offers the ability to switch between conversational and low code views. One advantage of the system is that it may improve in its NLP over time both in aggregate and as well as improving individual integration performance. The system can learn from low-code activities and use the interactions with NLP as compared to low-code interactions to offer additional training to the ML system and through the use of feedback generated from the data regarding the disparity between the NLP interpretation and the low-code specifications, system training and feedback may occur. Hence, the platform according to exemplary embodiments may better translate the user's instructions using ML with more accurate interpretation of the user's intent. Hand-tuning and interpretation of the platform can further advance its accuracy. The combination of low-code and chatbot interfaces may allow users to rapidly bring about hyper automation transformations to their businesses by delivering RPA and integration technologies.

Exemplary embodiments can also allow for the discovery, also referred to as self-discovery, of APIs either through incorporation of standardized API catalogs or through a self-discovery process of making use of test-cases and examining inputs/outputs and validating the API and its subsequent integration. Exemplary embodiments provide the opportunity to discover and integrate multiple APIs from a comprehensive range of enterprise business software platforms.

API discovery can be further advanced with the inclusion of mapping intent to natural language commands. In this way, the system can expand in compatibility with enterprise software systems with or without human integration efforts either through direct software engineering between the enterprise systems or engineering of the platform according to exemplary embodiments that affords such integration.

In exemplary embodiments, the platform may be hosted on premises, i.e., on a computer used to perform the integration, on the cloud accessible remotely by a plurality of computers, and inside low code platforms, e.g., as an application inside of a service. In the case of a low code inside of a platform, the integration platform may be built as an application on top of the existing low code platform. An example may be configuring the platform as an application that can be installed in a service such as Appian, Salesforce, or ServiceNow.

The present invention may be equipped to receive instructions from the clients and programs in a variety of formats. The extractor may also extract select parts of the software.

Exemplary embodiments of the systems and methods include making use of language to enable integration without deep technical knowledge that is usually needed to effect enterprise software integrations. Natural language processing enables the ability to move from speech to text-based conversion. In addition, higher level language understanding is needed to enable useful dialog between natural language commands and the integration efforts. In order to effect these changes, the platform according to exemplary embodiments makes use of intent and entity extraction and utilization.

Exemplary embodiments make use of intent-based ML to facilitate software integrations and hyper-automation. An intent represents the purpose of a user's input. Exemplary embodiments include a platform to map an intent for each type of user request to the API and applications supported. Coupling entity extraction in the natural language processing (NLP) of the invention enables a term or object that is relevant to your intents and that provides a specific context for an intent. In the platform according to exemplary embodiments, example intents include adding connected systems and building or modifying integrations. The natural language interface can also be extended to allow users to query their data in addition to building integrations for their data. The ML used by the platform according to exemplary embodiments makes use of an ensemble of deep neural networks and decision/dialogue tree models. At runtime, both the rules based decision tree and ML methods may be used simultaneously or contemporaneously, and a confidence score may be calculated for each based on previous user experiences. Whichever method returns a higher confidence may be used to select the appropriate response to the end user. In certain cases, the range of allowable responses may be so narrow that ML may not need to be used at all, and decision trees may be configured to provide the full suite of functionality.

Exemplary embodiments can also enable mapping of intent to entities that may be pre-defined in the platform either by manual coding or by automated discovery or application programming interface (API) discovery process that can automatically map the functionality of the API along with the possible functional manipulations which are possible with given entities. The intent-matching step is the initial “fuzzy” step, where the bot attempts to understand what the user is trying to do in general. Example intents include adding connected systems and building or modifying integrations. Each intent may have a desired or predetermined parameters associated therewith, which the bot attempts to identify by prompting the user(s) for the specific values of each parameter (slot filling). When possible, machine learning is used during slot filling to avoid a user having to memorize specific terms or vocabulary. If the parameters are expressed in the initial intent, the bot may be configured to directly extract them and avoid the need for additional prompts. For example, a user may state they want to build an integration and also detail many of the specifics of that integration in a single utterance.

Machine language systems and methods for building software applications may include a knowledge base, an application scenario player, a service connector, presentation components, and underlying system component-services. In exemplary embodiments, instead of using “almost natural language,” users can communicate directly in natural language with the platform. In exemplary embodiments, the integration and use of speech affords the opportunity for the speech to interact simultaneously or contemporaneously with integrations and a systematic, orchestrated integration service that can contain dedicated code both on a macro level, i.e., for all systems involved via, for example, the cloud, as well as the individual enterprise software level and on-premise level. Furthermore, the system affords a dynamic query capability of all of these systems for question and answer and escalation of these questions to a ticketed system to enable human intervention if and when needed. Exemplary embodiments create an agnostic speech interface for inclusion of different third-party, and/or more specialized bots, as well as integration of different code or low-code systems. Exemplary embodiments provide added flexibility due to the use of speech to interrogate the actual end-user data itself and its ability to work with a wide range of application APIs that can be auto-discovered and exposed to the speech/bot interface. In exemplary embodiments, the controlled vocabulary and use of ML allows to refine the relationship between intent and entity extraction on an aggregate basis, e.g. to optimize both a single tenant system or globally using these insights across all systems, as well as enhance individual profiles by learning from integration success and proxies for success, sentiment analysis of communications and human-based training and audit review.

In exemplary embodiments, technology which can be utilized in the platform according to exemplary embodiments may include, e.g., Google Dialogflow. Dialogflow is an end-to-end, “build-once deploy-everywhere” development suite for creating conversational interfaces for websites, mobile applications, popular messaging platforms, and IoT devices.

Predictive analytics to optimize integrations/conversion/extractions/deployments—Exemplary embodiments include the use of algorithmic and predictive integration to enable systematic integration. While the programmatic features of the system afford the ability to directly integrate using the APIs of the various enterprise software systems, there is also the opportunity to make use of the software driven integration platform that the invention can enable. Exemplary embodiments provides a software-based integration platform that both contains a rule-based integration decision tree which can provide higher likelihood of successful integrations without violation of methods and connectivity which result in invalid data flow as well as systematic methods of monitoring for software error ‘codes’ from either the enterprise software or the inventive integrative platform. In addition, the platform can perform tests to validate proper data integration as well as running preventive and workflow diagnostics to provide use case and test case based testing.

In exemplary embodiments, predictive analytics can be provided that adapts and optimizes changes in when updates or changes occur in one system, integration changes are automatically adjusted to accommodate these changes without need for human intervention. Such predictive analytics can be a combination of a hierarchical rule-based system and/or machine learning system that affords insights that can be either directly translated into integration changes or offered to the end-user as recommendations or alerts to consider before or after making a change in the integration.

In some embodiments, the platform can make use of specialized Chatbots that have domain specific language and algorithms that are specific for particular tasks and/or particular enterprise systems.

Exemplary embodiments may learn from the selected option selections as well as feedback from the system (including violation notices, analytics, measures of data integrity) to better recommend these suggestions to individual users and organizations. This capability is aimed to provide many of the fields entered and options selected in the system.

The platform according to exemplary embodiments also makes use of macro information, meta-data and other data sourcing (including aggregate user data, single tenant specific and end-user data) in creating recommendations. Exemplary embodiments can also effectively create a hierarchy of chatbots in at least the following ways:
1. Integrating with external chatbots: Integrated systems may contain chatbots or be chatbot systems, in which case the platform can redirect users to specific chatbots when appropriate based on the user's context.
2. Exposing APIs as chatbots: The system may be configured to expose discovered APIs as chatbots. For any given API, there is a set of required and optional fields. When combined with the context of the purpose of each API, the platform may be configured to generate a unique chat experience for each connected API, even if those APIs do not normally have chatbots associated with them.
3. Custom Bots: End users may be able to create custom bots using the low/no-code and conversational interfaces by creating questions, intents, and slots. The system may be configured to forward user from bot to bot as needed, combining all of their capabilities to enrich the user experience.

Extracting Analytics Workflows using Conversational artificial intelligence (AI)—The platform according to exemplary embodiments can also provide bi-directional insights/communication through automated testing, recommendations and other data that is informed by system status and analysis of meta-data that is generated from the platform according to exemplary embodiments and the enterprise use. The platform according to exemplary embodiments, is also configured to show analytics workflows both of the platform itself as well as the constituent enterprise software packages that make up the integrated system of an organization.

The platform according to exemplary embodiments can also serve to provide the following functionality: i) Automated testing of workflows and end-point confirmation analysis; ii) Performance monitoring and data synchronization; iii) Field level mapping recommendations—based on prior integrations, integration logic, feedback from customers on integration success—based on pre-programmed intent-based logic, taxonomy and rule-based algorithms; iv) Q&A for common user questions.

In exemplary embodiments, smart integration may include automatically performed tasks, or tasks performed based on a given environment such as, e.g., automatically updating workflows, code, software configurations, and automatically updating various services such as email and the like. In exemplary embodiments, smart integrations may allow for full-fledged application development in connected systems.

In exemplary embodiments, the system may learn from the selected options to better recommend them to individual users and organizations. This may be the case for the majority of fields entered and options selected in the system.

Different users of a given instance of the system can have different permissions. For example, platform owners may choose to let all users be able to integrate with ServiceNow, but only let some integrate with S3. In addition, the recommendation engine is configured to learn individual user and organizational behavior to power recommendations. Blockchain is configured to record in a ledger the different permissions and individual integrations of each user in the system.

VI. Other Exemplary Features

These and other features and advantages are described in, or are apparent from, the following detailed description of various example embodiments.

It may be understood that, although the terms “first”, “second”, etc. may be used herein to describe various elements, components, regions, layers and/or sections, these elements, components, regions, layers and/or sections may not be limited by these terms. These terms are only used to distinguish one element, component, region, layer or section from another element, component, region, layer or section. Thus, a first element, component, region, layer or section discussed below may be termed a second element, component, region, layer or section without departing from the teachings of example embodiments.

In the drawing figures, the dimensions of layers and regions may be exaggerated for clarity of illustration. Like reference numerals refer to like elements throughout. The same reference numbers indicate the same components throughout the specification.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It may be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It may be further understood that terms, such as those defined in commonly-used dictionaries, may be interpreted as having a meaning that is consistent with their meaning in the context of the relevant art and may not be interpreted in an idealized or overly formal sense unless expressly so defined herein. As used herein, expressions such as “at least one of,” when preceding a list of elements, modify the entire list of elements and do not modify the individual elements of the list.

One embodiment is a software development tool for developing software that implements a customer's business processes. The software development tool determines a plurality of models to define the software to be developed, wherein at least one model of the plurality of models is a business model that comprises at least one business process, and the at least one business process is a set of interrelated business process paths that accomplish a business goal. The software development tool defines at least one business process path, wherein the at least one business process path is a route through the at least one business process taken during a single execution of the at least one business process, and the at least one business process path comprises at least one step. The software development tool maps the defined at least one business process path to a second model different than the business model, wherein the mapping identifies at least one part of the second model that implements the at least one step of the business process path. The software development tool builds the at least one business process path based on results of the mapping. The software development tool delivers the at least one business process path that has been built.

Some embodiments may be related to a document processing framework for robotic process automation.

In an embodiment, a computer program is embodied on a non-transitory computer-readable medium. The program is configured to cause at least one processor to automatically classify a file into one or more document types using one or more classifiers in an RPA workflow and store results of the automatic classification in a classification data structure. The program is also configured to cause the at least one processor to automatically extract data from the classified file using one or more extractors in the RPA workflow and store the automatically extracted data in an extraction data structure. The program is further configured to cause the at least one processor to output the automatically extracted data.

In another embodiment, a computer-implemented method includes receiving, by a computing system, a list of defined document types and associated fields for each of the defined document types from a taxonomy manager and storing the list of document types and the associated fields in a master taxonomy data structure, by the computing system. The computer-implemented method also includes automatically classifying the file into one or more document types, by the computing system, using one or more classifiers in an RPA workflow and storing results of the automatic classification in a classification data structure, by the computing system. The computer-implemented method further includes outputting the results of the automatic classification, by the computing system.

In yet another embodiment, a system includes memory storing computer program instructions and at least one processor configured to execute the computer program instructions. The instructions are configured to cause the at least one processor to receive a list of defined document types and associated fields for each of the defined document types from a taxonomy manager. The instructions are also configured to cause the at least one processor to execute a digitization activity in an RPA workflow and output a text version of a file and a Document Object Model (DOM). The instructions are further configured to cause the at least one processor to automatically classify the file into one or more document types using one or more classifiers in the RPA workflow and automatically extract data from the classified document using one or more extractors in the RPA workflow. Additionally, the instructions are further configured to cause the at least one processor to output the automatically extracted data.

Some embodiments may feature a software development tool for developing software that implements a customer's business processes. The software development tool determines a plurality of models to define the software to be developed, wherein at least one model of the plurality of models is a business model that comprises at least one business process, and the at least one business process is a set of interrelated business process paths that accomplish a business goal. The software development tool defines at least one business process path, wherein the at least one business process path is a route through the at least one business process taken during a single execution of the at least one business process, and the at least one business process path comprises at least one step. The software development tool maps the defined at least one business process path to a second model different than the business model, wherein the mapping identifies at least one part of the second model that implements the at least one step of the business process path. The software development tool builds the at least one business process path based on results of the mapping. The software development tool delivers the at least one business process path that has been built.

When the terms “about” or “substantially” are used in this specification in connection with a numerical value, it is intended that the associated numerical value include a tolerance of ±10% around the stated numerical value. Moreover, when reference is made to percentages in this specification, it is intended that those percentages are based on weight, i.e., weight percentages. The expression “up to” includes amounts of zero to the expressed upper limit and all values therebetween. When ranges are specified, the range includes all values therebetween such as increments of 0.1%. Moreover, when the words “generally” and “substantially” are used in connection with geometric shapes, it is intended that precision of the geometric shape is not required but that latitude for the shape is within the scope of the disclosure. Although the tubular elements of the embodiments may be cylindrical, other tubular cross-sectional forms are contemplated, such as square, rectangular, oval, triangular and others.

Reference may now be made in detail to embodiments, examples of which are illustrated in the accompanying drawings, wherein like reference numerals refer to the like elements throughout. In this regard, the present embodiments may have different forms and may not be construed as being limited to the descriptions set forth herein. Accordingly, the embodiments are merely described below, by referring to the figures, to explain example embodiments of the present description.

In one embodiment, there may be a novel method for extracting software development requirements from natural language information. In one example, the method may include receiving, by a requirements extraction device, structured text data related to a software development. The structured text data may be derived from natural language information. The method may further include extracting, by the requirements extraction device, a plurality of features for each of a plurality of sentences in the structured text data. The plurality of features may include at least one of token based patterns, unique words frequency, or word embeddings. The method may further include determining, by the requirements extraction device, a set of requirement classes and a set of confidence scores for each of the plurality of sentences, based on the plurality of features, using a set of classification models. The set of classification models may include at least one of a pattern recognition model, an ensemble model, or a deep learning model. The method may further include deriving, by the requirements extraction device, a final requirement class and a final confidence score for each of the plurality of sentences based on the set of requirement classes and the set of confidence scores for each of the plurality of sentences corresponding to the set of classification models. The method may further include providing, by the requirement extraction device, the software development requirements based on the final requirement class and the final confidence score for each of the plurality of sentences.

In another embodiment, a system for extracting software development requirements from natural language information is disclosed. In one example, the system may include a processor, and a computer-readable medium communicatively coupled to the processor. The computer readable medium may store processor-executable instructions, which when executed by the processor, may cause the processor to receive structured text data related to a software development. The structured text data may be derived from natural language information. The stored processor-executable instructions, on execution, may further cause the processor to extract a plurality of features for each of a plurality of sentences in the structured text data. The plurality of features may include at least one of token based patterns, unique words frequency, or word embeddings. The stored processor-executable instructions, on execution, may further cause the processor to determine a set of requirement classes and a set of confidence scores for each of the plurality of sentences, based on the plurality of features, using a set of classification models. The set of classification models may include at least one of a pattern recognition model, an ensemble model, or a deep learning model. The stored processor-executable instructions, on execution, may further cause the processor to derive a final requirement class and a final confidence score for each of the plurality of sentences based on the set of requirement classes and the set of confidence scores for each of the plurality of sentences corresponding to the set of classification models. The stored processor-executable instructions, on execution, may further cause the processor to provide the software development requirements based on the final requirement class and the final confidence score for each of the plurality of sentences.

In one embodiment, a non-transitory computer-readable medium storing computer-executable instructions for extracting software development requirements from natural language information is disclosed. In one example, the stored instructions, when executed by a processor, may cause the processor to perform operations including receiving structured text data related to a software development. The structured text data may be derived from natural language information. The operations may further include extracting a plurality of features for each of a plurality of sentences in the structured text data. The plurality of features may include at least one of token based patterns, unique words frequency, or word embeddings. The operations may further include determining a set of requirement classes and a set of confidence scores for each of the plurality of sentences, based on the plurality of features, using a set of classification models. The set of classification models may include at least one of a pattern recognition model, an ensemble model, or a deep learning model. The operations may further include deriving a final requirement class and a final confidence score for each of the plurality of sentences based on the set of requirement classes and the set of confidence scores for each of the plurality of sentences corresponding to the set of classification models. The operations may further include providing the software development requirements based on the final requirement class and the final confidence score for each of the plurality of sentences.

Example embodiments may include a system, a method, and/or a computer program product at any possible technical detail level of integration. The computer program product may include a computer readable storage medium (or media) having computer readable program instructions thereon for causing a processor to carry out example embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform example embodiments.

Example embodiments are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

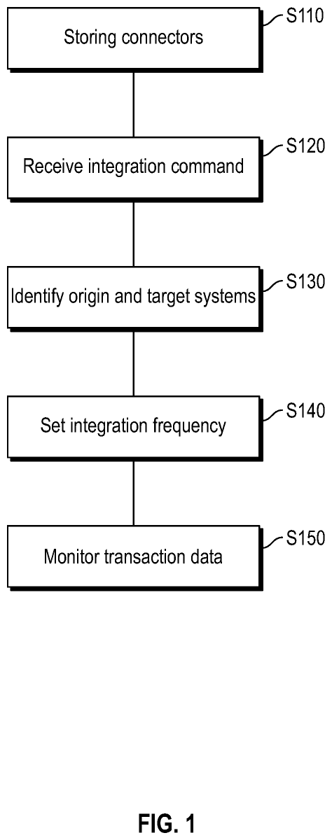

FIG. 1 is a flowchart illustrating a method of software integration in accordance with example embodiments. In example embodiments, the method starts at step S110 where prebuilt connectors are stored. A system according to various example embodiments stores a list of prebuilt connectors, such as, e.g., Salesforce, ServiceNow, Jira, and the like. In example embodiments, connectors can also be applications, application programming interfaces (APIs), or even conversational/robotic process automation (RPA) Bots, allowing users to string together and orchestrate bots with their applications.

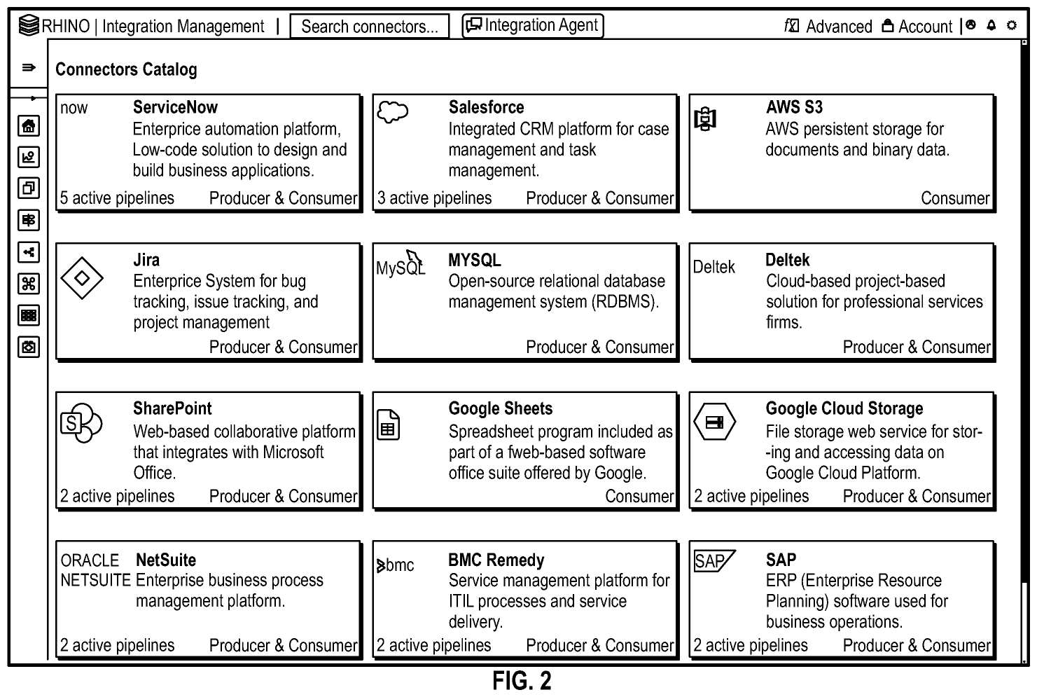

In example embodiments, connectors have prebuilt actions and events associated with the prebuilt actions. In example embodiments, an event is something that happens in a system such as e.g., the creation of a bug, the updating of a record, or the sending of an email. In example embodiments, an action is something that you want done in a system, such as creating a record or running a process. In principle, events and actions are interchangeable. Details of prebuilt connectors are provided in FIG. 2, which illustrates a list of pre-existing connectors, according to various example embodiments. In exemplary embodiments, connectors may include databases, automation platforms, chatbots, custom systems, and software applications both hosted on the cloud and on premise.

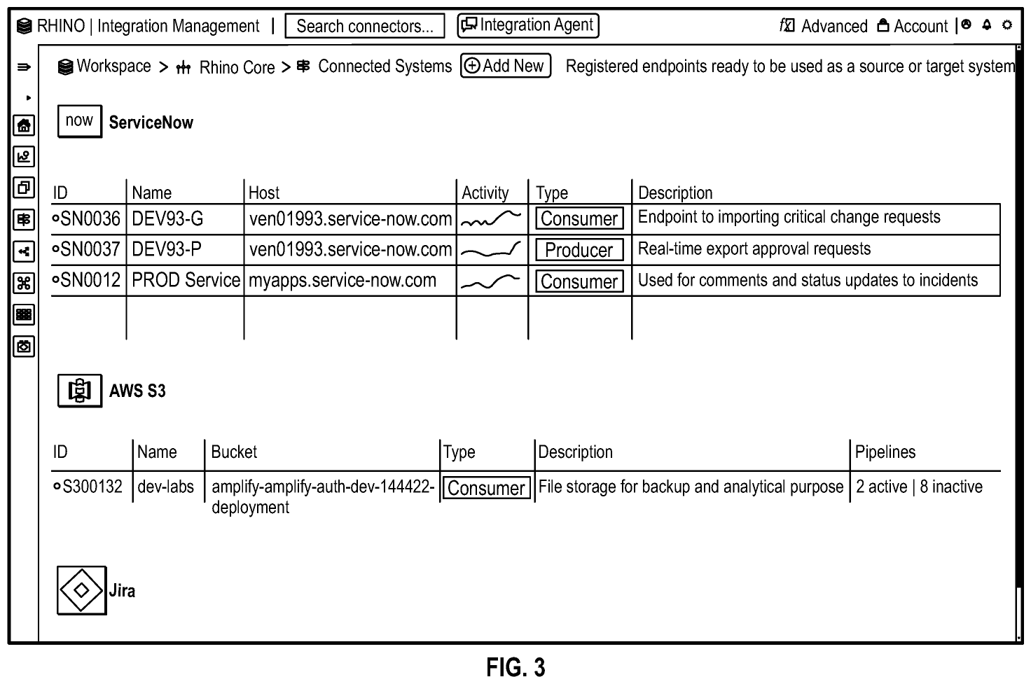

In example embodiments, a connected system is a specific instance of a connector. For example, while the system comes with a ServiceNow connector, a user may need to connect to multiple different connected ServiceNow instances. Each of these instances may be a connected system. In exemplary embodiments, allowing multiple connected systems for a given connector lets end users connector multiple instances or servers of the same software. In example embodiments, the systems currently connected can be illustrated. Example connected systems are illustrated in FIG. 3, according to various example embodiments.

In example embodiments, the method at step S120 receives instructions to start integration or automation. For example, the sending of an email may be the event that initiates an integration, while the very same email may be sent as a result of the action of another integration. In example embodiments, users become able to create custom connectors and define the actions and events for them, enabling them to expose custom APIs and applications which do not currently have pre built connectors.

In example embodiments, the method at step S130 determines which service or services are the origin systems, i.e., service(s) to be integrated into one or more target services. In example embodiments, a user can build an integration by selecting a source connected system, a target connected system, and events and actions for those systems. In example embodiments, the user may be able to select multiple targets and actions that can be initiated from an event. For example, the target is Jira and MySQL and the action is to post an incident when it is created in Service Now.

In example embodiments, the method at step S140 sets the frequency of integration. In example embodiments, a user may be able to enter the frequency of an integration. In exemplary embodiments, the system may recommend a frequency based on the previously selected fields, favoring real-time integrations when appropriate and possible. In example embodiments, a user may indicate if an integration is one way or bidirectional. In example embodiments, a user is able to map data between actions and events using, e.g., machine learning (ML)-assisted graphical user interface (GUI).

In example embodiments, as integrations take place as discussed above, the transactions occurring between the integrated services may be stored for further analysis.

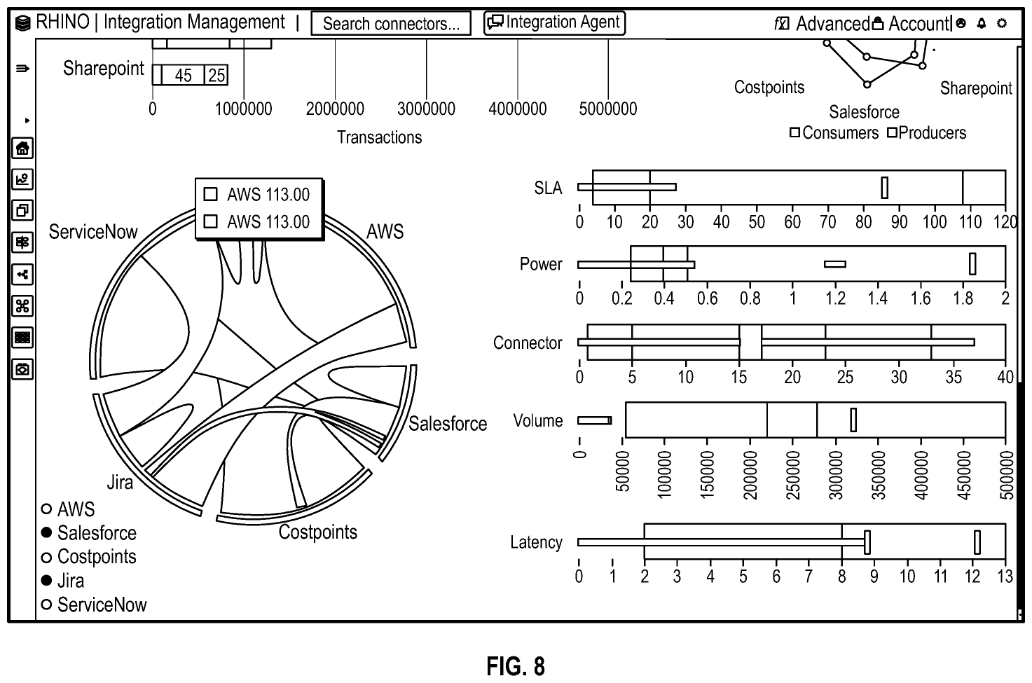

Integration Features: In example embodiments, each integration that is created may be run at the interval specified during creation (in real time, hourly, or daily). As integrations run, requests may be made to both source- and target-connected systems in order to identify events and perform actions. In example embodiments, transactions may be stored for analysis. FIG. 8 discussed below is an illustration of transactions reporting between various systems, according to various example embodiments.

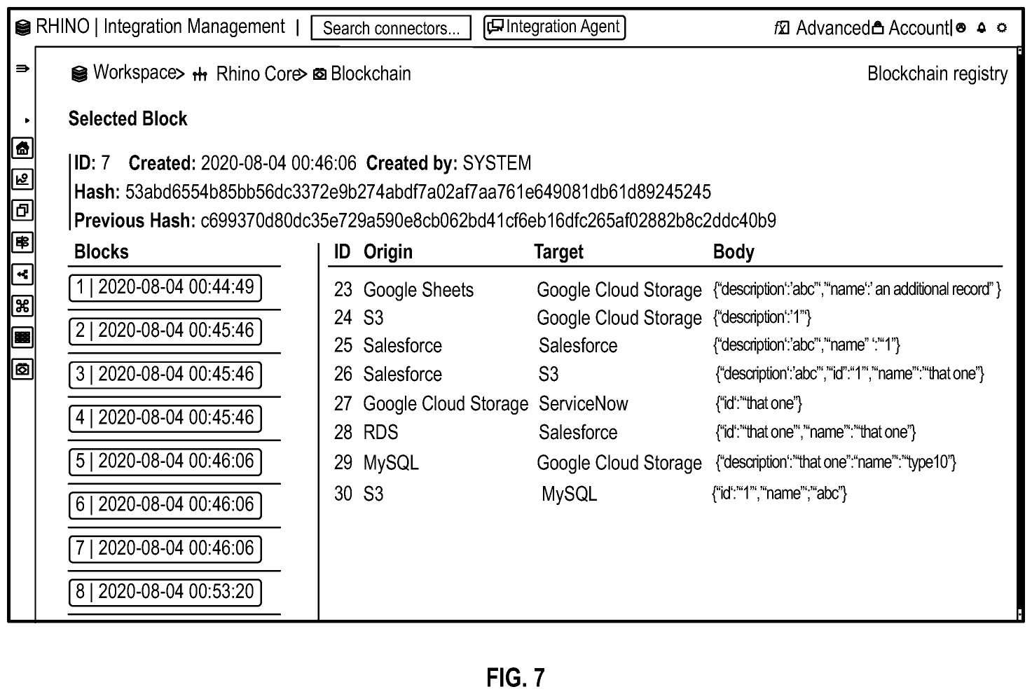

In example embodiments, the method at step S150 monitors the data that is transferred as a result of the integration. In example embodiments, the system may periodically check connected systems for improper edits, and automatically correct them. In exemplary embodiments, users may also choose for the system to notify them and report on issues to allow for manual correction instead of automatic correction. In example embodiments, the user may configure for notifications to be sent upon the identification of bad data and/or to not autocorrect issues if needed. In example embodiments, transactions may also be stored in a blockchain ledger for data integrity. FIG. 7 is an illustration of a blockchain registry, according to various example embodiments. In example embodiments, the blockchain registry lists the transactions that are or have been logged for each block.

In example embodiments, the system may monitor, e.g., automatically monitor, the response times from interactions with external systems to identify performance issues in advance. Once these are identified, the system may automatically slow down integrations to protect the connected systems. In example embodiments, transactions taking place during or for the purpose of an integration may be analyzed by end users to query, sort, and visualize integration features.

In example embodiments, the system design may include the following: i) Event Driven—In example embodiments, system components communicate through a common event log as opposed to through APIs to maximize scalability and performance; ii) Serverless Technologies—As much as possible, the system may use serverless technologies and containers to maximize scalability and performance while keeping costs low; iii) Micro/Nanoservices—In example embodiments, the system is designed as a series of small components, each with their own functionality. The components communicate primarily through the event log. In exemplary embodiments, the separation of concerns provided by a microservices design may allow for a reduction in system complexity and an increase in development speed.

In example embodiments, to add additional capabilities of the method, a platform configured to implement the method may provide an API and can be integrated with tools that facilitate enterprise integration (such as Salesforce, IBCO, Boomi, Informatica, Talend, Adeptia, Cleo, Axway, Jitterbit, Spring, Amazon Web Services (AWS)). In addition, the system can be integrated with systems that provide additional enterprise IT management capabilities such as Moogsoft as well as virtual machine software and on-premise management software packages.

Example embodiments can make use of menu-based bots (also known as chatbots), where users select a path based on a menu of options that the bot delivers to the end user. The platform according to example embodiments exposed connected enterprise systems as Bots. The Bots expose connected systems as bots where users can perform actions through the use of speech. NLP Bots, which rely on natural language processing to interpret free text and make use of intent and entity extraction, interpretation and mapping to functional actions involving software integration.

In the case of NLP bots, a user may ask natural language questions in a dialog box, i.e., to a virtual developer, and an answer may be provided back to the user based on information available in the integrated systems. If more specifics are required to formulate the answer, the user may be prompted for clarifications. Such mapping can be further informed and refined by both manual input and refinements to machine learning systems coupled with rules-based algorithms that define software specific systems as well as general logic that is generically applicable to a wider range of software systems.

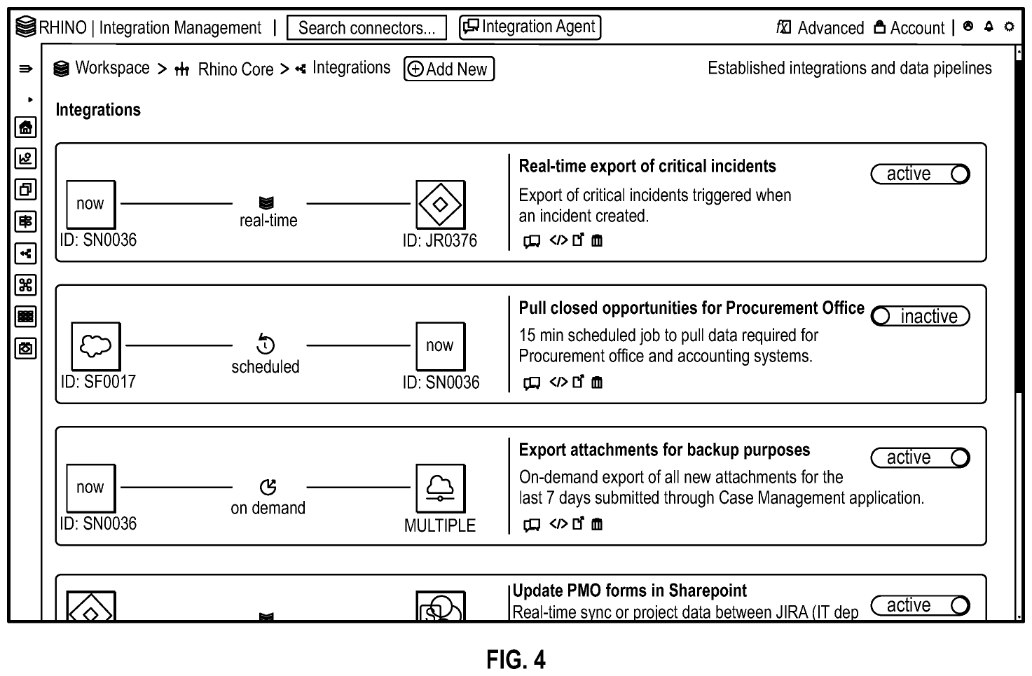

Examples of connected services is provided in FIG. 3. The platform can also refine its ML models through the use of aggregate integration data coupled with curated outcomes data (such as self-reported feedback of the integration, sentiment analysis (both automated and/or manual) of bot correspondence and objective measures of integration efficacy such as results of log-files, data validation, and any violation or help desk issues that occur after an integration). Integration with tools such as Service Now which is a ticketing tool that processes and catalogs, customer service requests, providing reporting data on incidents, changes, problems, and other services using tools like ServiceNow. ServiceNow integration can enable quantitative and qualitative feedback from ServiceNow and other ticketing and integration services. Integration can be understood as the coupling of two or more connected systems, and FIG. 4 is an illustration of integrations, according to various example embodiments.

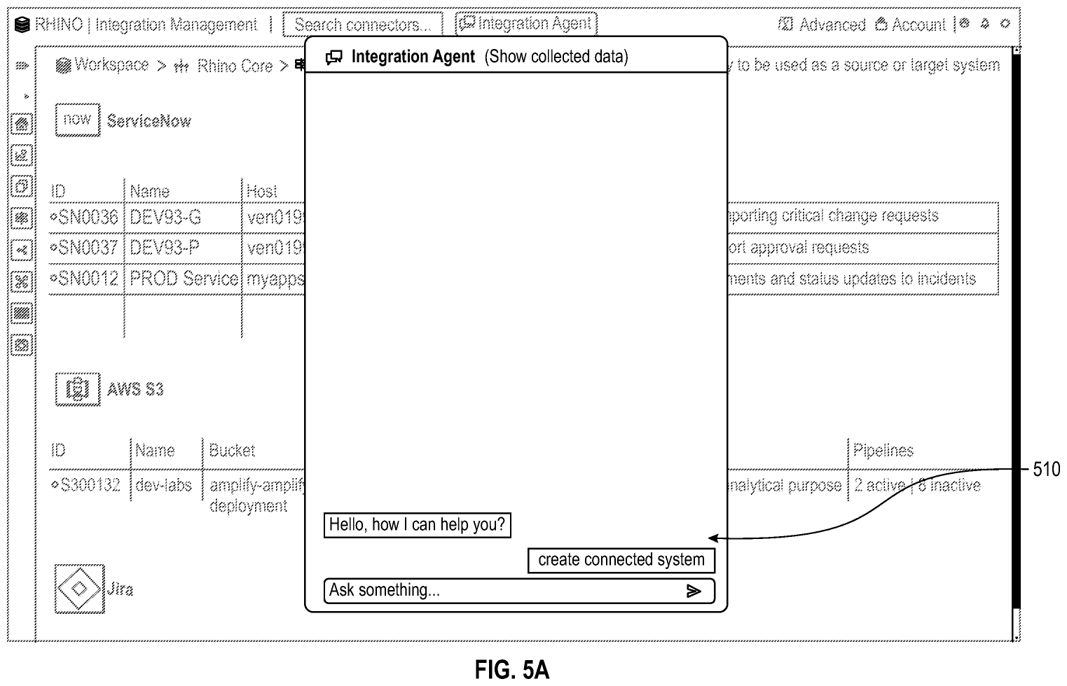

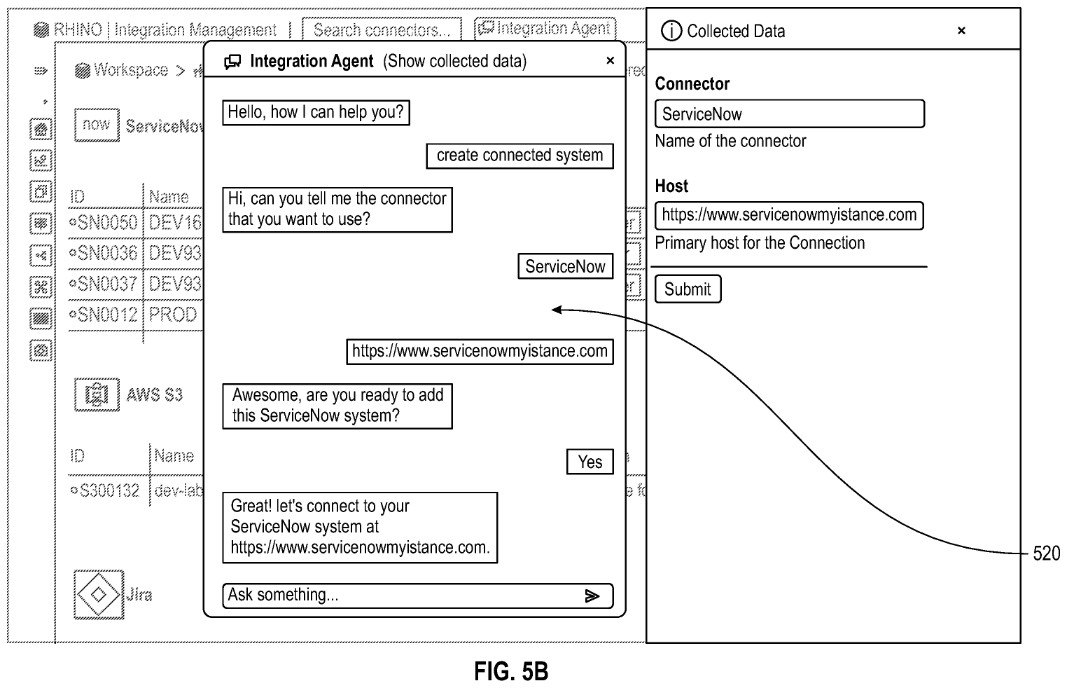

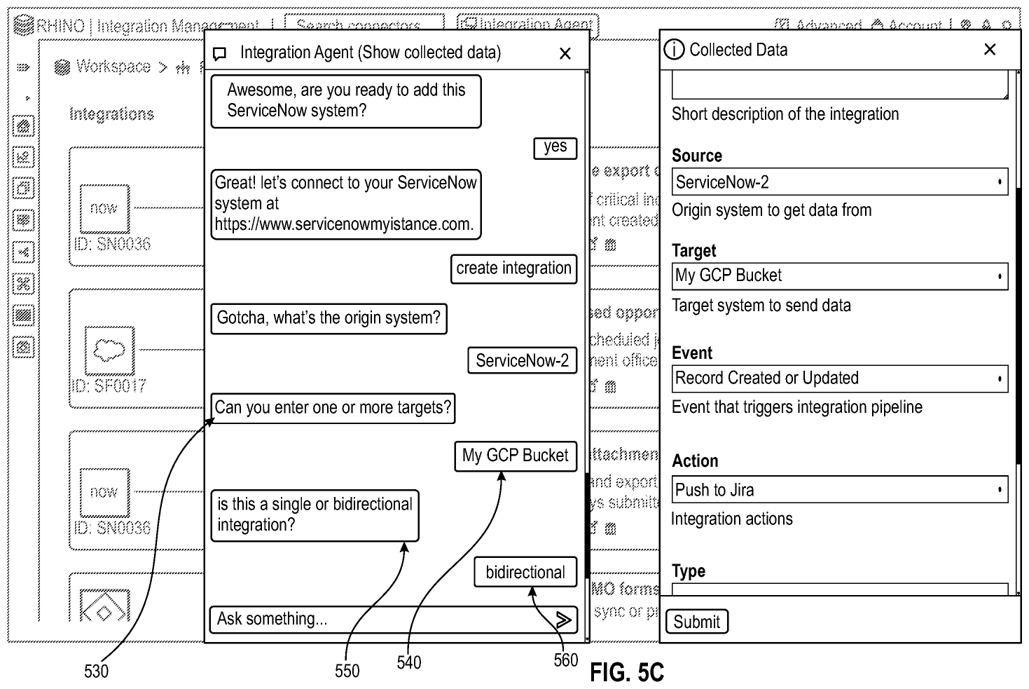

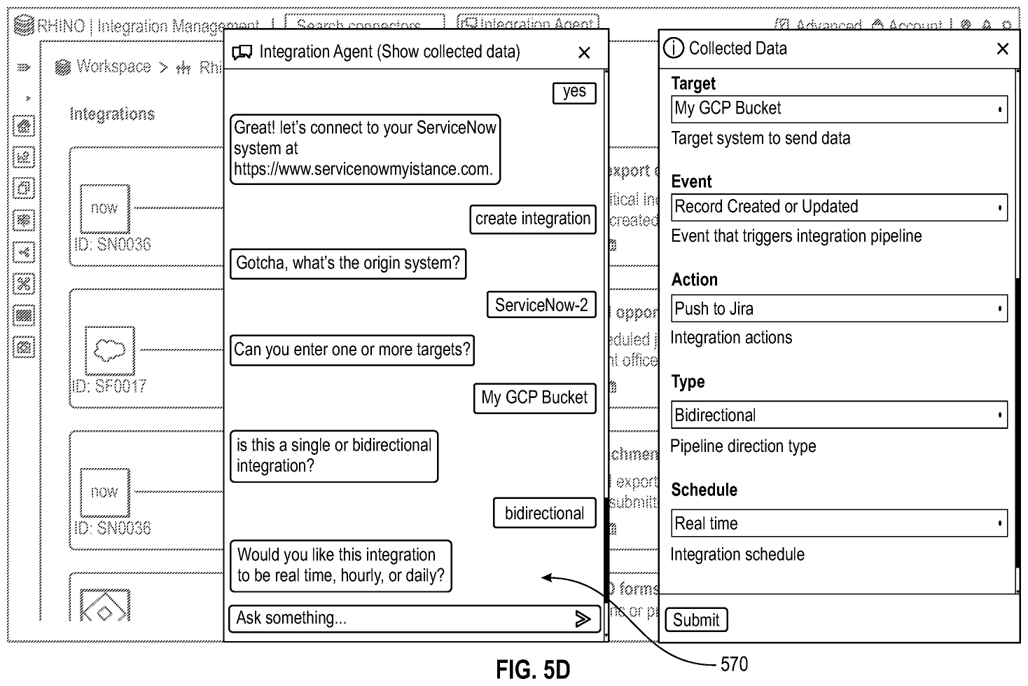

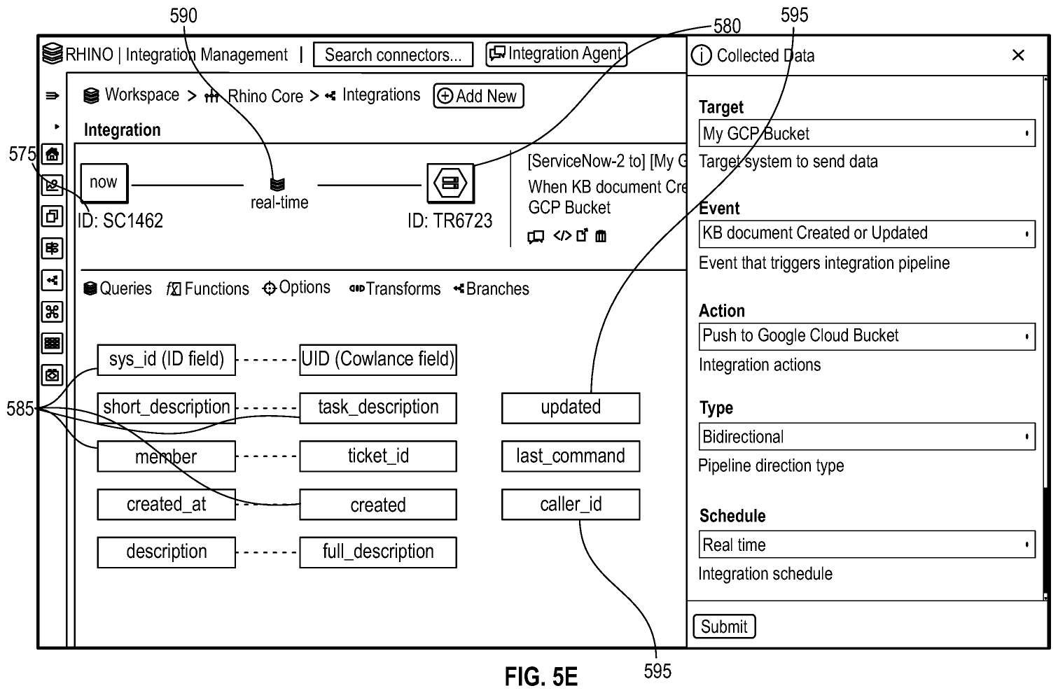

An example of the creation of an integration or process automation via a chatbot is illustrated in FIGS. 5A-5D, according to various example embodiments. In FIG. 5A, the integration starts when a command 510 to, e.g., “create an integration” is entered in the chat box. In exemplary embodiments, the user may not need to enter that exact command, as the NLP algorithms can interpret the meaning of natural language. For example, a user could say “I want to create a process automation”, or “let's make an integration”, or “I want to automatically integrate ServiceNow with Jira”, and the like. In all of the previous examples, the system may still understand that the user wants to create an integration and begin the creation process. In response, as illustrated in FIG. 5B, the system according to various example embodiments enters into an interactive exchange 520 to identify which origin service to integrate. In the illustrated example, the origin system is identified as “ServiceNow.” FIG. 5C illustrates the integration of files from ServiceNow to allow documents to flow from ServiceNow to another service, in this case Google Cloud Storage. In example embodiments, the system request entry 530 of one or more target services. When the target service is entered in chat box 540, in example embodiments, the method may request clarification of whether the integration is unidirectional of bidirectional in chat box 550. Unidirectional integration is when integration is from only one service to another. For example, unidirectional integration of documents from ServiceNow to Google Cloud Storage is the integration of documents only from ServiceNow to Google Cloud Storage but not from Google Cloud Storage to ServiceNow. Bidirectional integration between ServiceNow and Google Cloud Storage allows the flow of documents from ServiceNow to Google Cloud

Storage as well as from Google Cloud Storage to ServiceNow. In example embodiments, the directionality of the integration can be entered in chat box 560. In example embodiments, the method may request entry of the frequency of integration, e.g., real time, hourly or daily, in chat box 570.

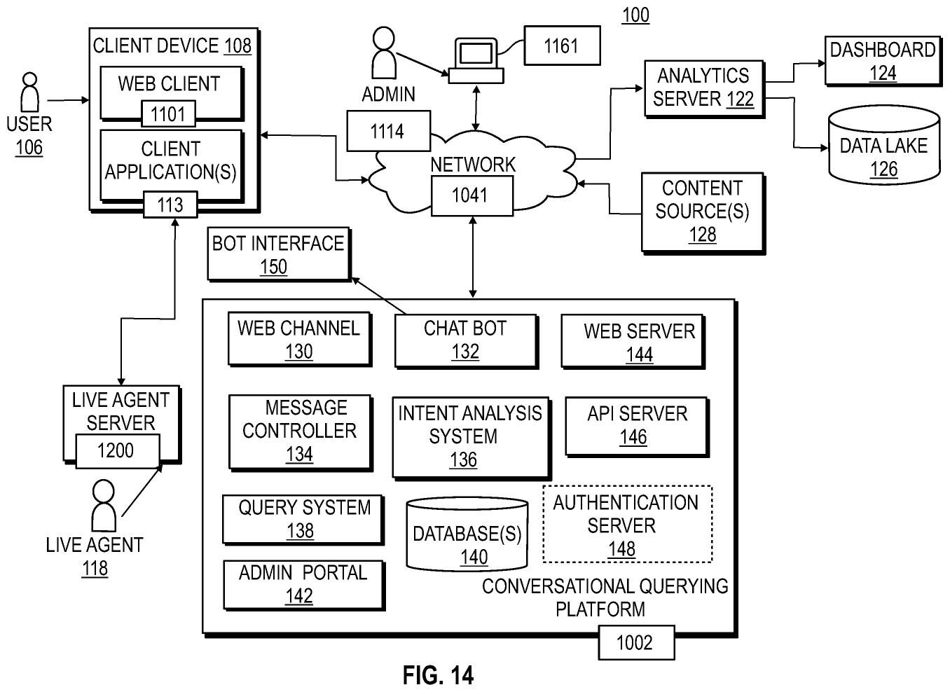

In example embodiments, although the above integration parameters are entered in a piecemeal fashion by successive prompts, the entire integration parameters may be entered in one continuous line of natural language instruction. A greater discussion of the configuration of chatbots providing information in a conversational environment is provided below with respect to FIG. 14.

In example embodiments, the system may also provide the capability of further escalation to a consultative human-based developer to resolve integration challenges. To further the ability to offer bi-directional exchange between the end-user and the platform according to example embodiments, the system also offers dynamic question-answer (QA) regarding the integration process and integration status, as well as validation and violations and other integration metrics. As violations and errors occur, the system may report to end-users, notify them through email with recommendations for fixes, and attempt to auto correct the issue when appropriate. Users may be able to enable or disable any of these violation features. This dynamic QA can make use of the Integration Platform as a Service (IPaaS) and other standards for dynamically recording system status and integrations such as IT service management (ITSM) and others.

The platform according to example embodiments can also provide higher accuracy of the NLP by enabling the ability to transverse a taxonomy of vocabulary associated with integration tasks at different levels or steps of the integration as well as consideration of different enterprise software packages.

In example embodiments, if the intent and/or entit(ies) cannot be determined from instructions entered by a user, the NLP can suggest the closest matches from a library, or enable manual low- or no-coding. This step can also occur during an integration if/when the system or the end-user determines that it is useful to switch modality from NLP to low or no code. In example embodiments, a low-code wizard may be available for record creation. Both the core chatbot and the low code wizard are synchronized with respect to user inputs so that a user can start a process through one and finish through another. In addition, while not preferred, a simple excel-like language of functions can be used when complex mappings are required such as string substitutions or aggregations. In example embodiments, low code is a visual approach to software development which abstracts and automates every step of the application lifecycle to enable rapid delivery of a variety of software solutions. For example, a low code approach allows developers to drag and drop application components, connect them together and create, e.g., an application.

In example embodiments, NLP is coupled with Chatbot technology to enable text and/or voice based interaction with the system. Many traditional enterprise platforms offer the ability to switch between low code and traditional coding views. We are instead offering the ability to switch between conversational and low code views. In exemplary embodiments, this may allow users to see in real time how their conversation with the Chatbot impacts the building of the software, by viewing the automatic updating of the low code interface as they talk to the Chatbot. Conversely, the Chatbot may be aware of all updates made directly to the low code interface. In exemplary embodiments, an advantage of the system is that NLP may improve over time in aggregate as well as improving individual integration performance. The system can learn from low-code activities and use the interactions with NLP as compared to low-code interactions to offer additional training to the ML system and through the use of feedback generated from the data regarding the disparity between the NLP interpretation and the low-code specifications, system training and feedback may occur. Hence, the platform according to example embodiments may better translate the user's instructions using ML with more accurate interpretation of the user's intent. Hand-tuning and interpretation of the platform can further advance its accuracy. The combination of low-code and chatbot interfaces may allow users to rapidly bring about hyper automation transformations to their businesses by delivering RPA and integration technologies.

Example embodiments can also allow for the discovery, also referred to as self-discovery, of APIs either through ingestion of standardized API catalogs or through a self-discovery process of making use of test-cases and examining inputs/outputs and validating the API and its subsequent integration. Example embodiments provide the opportunity to discover and integrate multiple APIs from a comprehensive range of enterprise business software platforms.

API discovery can be further advanced with the inclusion of mapping intent to natural language commands. In this way, the system can expand in compatibility with enterprise software systems with or without human integration efforts either through direct software engineering between the enterprise systems or engineering of the platform according to example embodiments that affords such integration.

In example embodiments, the platform may be hosted on premises, i.e., on a computer used to perform the integration, on the cloud accessible remotely by a plurality of computers, and inside low code platforms, e.g., as an application inside of a service. In the case of a low code inside of a platform, the integration platform may be built as an application on top of the existing low code platform. An example would be configuring the platform as an application that can be installed in a service such as Appian, Salesforce, or ServiceNow.

FIG. 5E illustrates a user interface displaying the result of an integration, according to various example embodiments. In example embodiments, the origin service 575 and the target service 580 are displayed, and the integrated fields 585 are mapped, e.g., automatically mapped. In example embodiments, the display also includes the frequency of integration 590. In example embodiments, if the system does not automatically map the fields and leaves some unmapped fields 595, then the fields 595 may be manually mapped if such mapping is necessary or beneficial to the successful integration of the origin service 575 and the target service 580. In addition, users can manually update automatically configured mappings to fine tune integrations and automations. This can be done during the creation process or later to update an existing integration.

In example embodiments, the system also affords the capability to create reports based on natural language queries as well as join data from multiple different integrated systems. Tableau, Appian, QlikView, IBM Cognos, Oracle BI, Sisense, Dundas and others make use of speech and low and no code interfaces and enable use of multiple application integration for visualization and business intelligence. Some of these applications have integrated speech analytics (e.g., Tableau formed a partnership with AI speech analytics company VoiceBase to provide call center analytics). However, Chatbot and Voice are not currently integrated to provide configuration or to integrate their applications. On the other hand, the platform according to example embodiments can integrate its multi-modality approach to integration so as to integrate these applications into the enterprise environment.

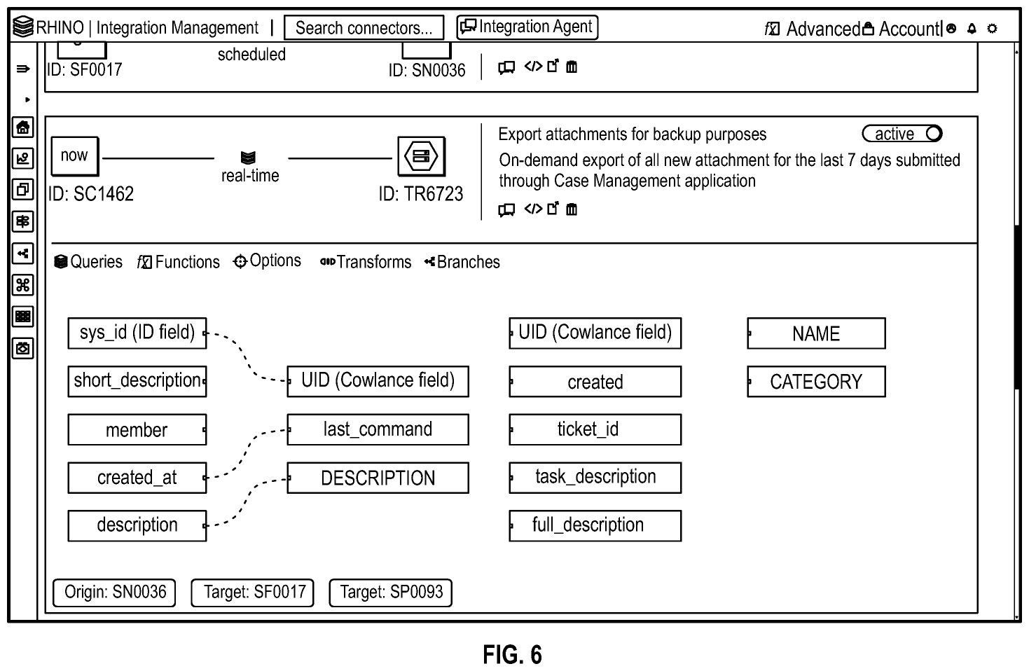

In example embodiments, the platform can also make use of meta-data regarding the person doing the integration to help inform appropriate use of vocabulary and to anticipate specific integration tasks that he/she may wish to perform. There is also the ability to examine integration history so as to inform the system if the integration is a “re-do” of a past integration versus a novel integration. There is also the ability to provide personalized NLP and intent/entity optimization based on individual ML profile which is optimized based on the individuals use, metadata and integration performance history. Example embodiments may also make use of hybrid Bots, which use menu-based methods and AI and Machine Learning based NLP methods at the right time to create a blended experience. Menu-based methods help to narrow down the branching decision trees to afford accurate mapping of user commands to actions. The use of full NLP can make use of a limited or predictive vocabulary that narrows the possible language ‘matches’ and increases accuracy of the NLP in the context of software integration. The bot may also recommend viable next actions to users, answer questions, and assist with auto completing forms. When needed, the bots can direct users to customer support agents to provide a seamless user experience. The platform according to example embodiments also provides an ‘escalation’ path to make use of natural language questions to the virtual developer, which may reach out to the integrated systems to attempt to formulate an answer. If it needs more specifics, it may prompt the user for them before responding. FIG. 6 is an illustration of mapped services, according to various example embodiments.

FIG. 8 is an illustration of transactions reporting between various systems, according to various example embodiments. For example, transactions reporting includes determining the amount of data being transmitted from one service to another after the integration between the two services is complete.

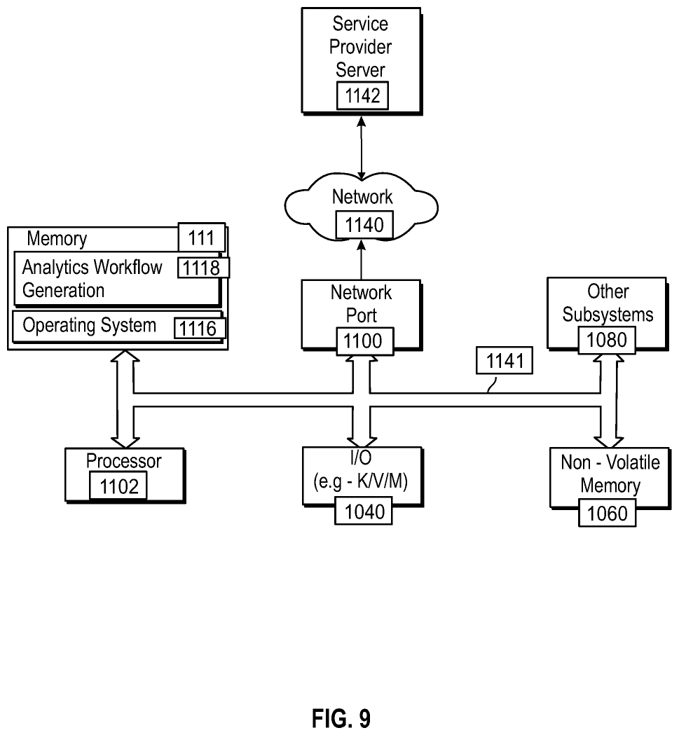

FIG. 9 is a diagram illustrating a general illustration of components of an information handling system. FIG. 9 is a generalized illustration of an information handling system 100 that can be used to implement the system and method of the present invention. The information handling system 100 includes a processor (e.g., central processor unit or “CPU”) 1102, input/output (I/O) devices 1040, such as a display, a keyboard, a mouse, and associated controllers, a hard drive or disk storage 1060, and various other subsystems 1080. In various embodiments, the information handling system 100 also includes network port 1100 operable to connect to a network 1140, which is likewise accessible by a service provider server 1142. The information handling system 100 likewise includes system memory 111, which is interconnected to the foregoing via one or more buses 1141. System memory 111 further comprises operating system (OS) 1116 and in various embodiments may also comprise an analytics workflow generation system 1118.

The analytics workflow generation system 1118 performs an analytics workflow generation operation. The analytics workflow generation operation enables generation of targeted analytics workflows created by one or more data scientists, i.e., experts in data modeling who are trained in and experienced in the application of mathematical, statistical, software and database engineering, and machine learning principles, as well as the algorithms, best practices, and approaches for solving data preparation, integration with database management systems as well as file systems and storage solutions, modeling, model evaluation, and model validation problems as they typically occur in real-world applications. These analytics workflows are then published to a workflow storage repository so that the targeted analytics workflows can be used by domain experts and self-service business end-users to solve specific classes of analytics operations.

More specifically, in certain embodiments, an analytics workflow generation system 1118 provides a user interface for data modelers and data scientists to generate parameterized analytic templates. In certain embodiments, the parameterized analytic templates include one or more of data preparation, data modeling, model evaluation, and model deployment steps specifically optimized for a particular domain and data sets of interest. For example, a particular business such as an insurance company may employ data-scientist-experts as well as internal citizen-data-scientist customers for those expert-data-scientists who may perform specific repeated data pre-processing and modeling tasks on typical data files and their specific esoteric data preparation and modeling requirements. Using the analytics workflow generation system 1118, a data scientist expert could publish templates to address specific business problems with typical data files for the customer (e.g., actuaries), and make the templates available to the customer to solve analytic problems specific to the customer, while shielding the customer from common data preparation as well as predictor and model selection tasks. In certain embodiments, the user interface to create analytic workflows is flexible to permit data scientists to select data management and analytical tools from a comprehensive palette, to parameterize analytic workflows, to provide the self-service business users the necessary flexibility to address the particular challenges and goals of their analyses, without having to understand data preparation and modeling tasks.

Next, in certain embodiments, the analytics workflow generation system 1118 provides self-service analytic user interfaces (such as web-based user interfaces) so that self-service users can choose the analytic workflow templates to solve their specific analytic problems. In certain embodiments, when providing the self-service analytic user interfaces, the system 118 analytics workflow generation accommodates role-based authentication so that particular groups of self-service users have access to the relevant templates to solve the analytic problems in their domain. In certain embodiments, the analytics workflow generation system 1118 allows self-service users to create defaults for parameterizations, and to configure certain aspects of the workflows as designed for (and allowed by) the data scientist creators of the workflows. In certain embodiments, the analytics workflow generation system allows self-service users to share their configurations with other self-service users in their group, to advance best-practices with respect to the particular analytic problems under consideration by the particular customer.

In certain embodiments, the analytics workflow generation system 1118 manages two facets of data modeling, a data scientist facet and a self-service end-user facet. More specifically, the data scientist facet allows experts (such as data scientist experts) to design data analysis flows for particular classes of problems. As and when needed experts define automation layers for resolving data quality issues, variable selection, best model or ensemble selection. This automation is applied behind the scenes when the citizen-data-scientist facet is used. The self-service end-user or citizen-data-scientist facet then enables the self-service end-users to work with the analytic flows and to apply specific parameterizations to solve their specific analytic problems in their domain.

Thus, the analytics workflow generation system 1118 enables high-quality predictive modeling by providing expert data scientists the ability to design “robots-that-design-robots,” i.e., templates that solve specific classes of problems for domain expert citizen-data scientists in the field. Such an analytics workflow generation system 1118 is applicable to manufacturing, insurance, banking, and practically all customers of an analytics system 118 such as the Dell Statistica Enterprise Analytics System. It will be appreciated that certain analytics system can provide the architectures for role-based shared analytics. Such an analytics workflow generation system 1118 addresses the issue of simplifying and accelerating predictive modeling for citizen data scientists, without compromising the quality and transparency of the models. Additionally, such an analytics workflow generation system 1118 enables more effective use of data scientists by a particular customer.

Although the above description refers to retrieving targeted parameterized analytics template from the workflow storage repository, the retrieving being performed by an end-user associated with the customer to solve a specific analytics need of the customer, the platform according to example embodiments is configured to dynamically integrate services based on end-user programmatic instruction.

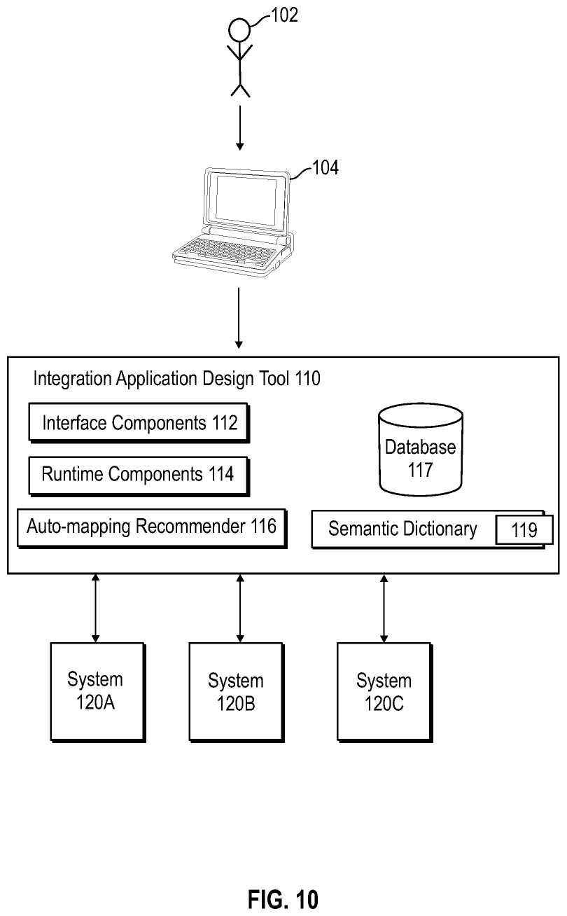

The following description of FIG. 10 below provides a more detailed discussion of an auto-recommender according to various examples.

FIG. 10 is a block diagram of environment 100 including an integration flow design tool, according to some embodiments. Any operation herein may be performed by any type of structure in the diagram, such as a module or dedicated device, in hardware, software, or any combination thereof. Any block in the block diagram of FIG. 10 may be regarded as a module, apparatus, dedicated device, general-purpose processor, engine, state machine, application, functional element, or related technology capable of and configured to perform its corresponding operation(s) described herein. Environment 100 may include user 102, device 104, integration application design tool 110, and systems 120.

User 102 may be a developer or other individual designing, developing, and deploying integration flows using an integration application design tool in an integration platform. User 102 may be a member of a business, organization, or other suitable group. User 102 may be a human being, but user 102 may also be an artificial intelligence construct. User 102 may employ, i.e., connect to, a network or combination of networks including the Internet, a local area network (LAN), a wide area network (WAN), a wireless network, a cellular network, or various other types of networks as would be appreciated by a person of ordinary skill in the art.

Device 104 may be a personal digital assistant, desktop workstation, laptop or notebook computer, netbook, tablet, smart phone, mobile phone, smart watch or other wearable, appliance, part of the Internet-of-Things, and/or embedded system, to name a few non-limiting examples, or any combination thereof. Although device 104 is illustrated in the example of FIG. 10 as a single computer, one skilled in the art(s) will understand that device 104 may represent two or more computers in communication with one another. Therefore, it will also be appreciated that any two or more components of device 104 may similarly be executed using some or all of the two or more computers in communication with one another.

Integration application design tool 110 may allow user 102 to design integration applications that access, manipulate, and otherwise use disparate technical resources. Integration application design tool 110 may provide a graphical design environment so user 102 may build, edit, deploy, monitor, and maintain integration applications. Integration application design tool 110 may provide a drag-and-drop interface that allows user 102 to leverage pre-built assets, security protocols, APIs, programming languages, and other suitable components. Integration application design tool 110 may standardize access to various data sources, provide connections to third-party systems and data, and provide additional functionalities to further integrate data from a wide-array of organizational and on-the-cloud data sources. Integration application design tool 110 may include user interface components 112, runtime components 114, auto-mapping recommender 116, data 117, and semantic dictionary 119.

Integration application design tool 110 may allow user 102 to create an integration flow. Two examples of integration flows are provided below. These integration

flows are merely exemplary, however, and one skilled in the relevant arts will appreciate that integration flows may perform a vast and expansive array of functions that may differ between individuals and among organizations. Some integration flows may incorporate dozens or even hundreds of assets into the integration scenario.

In one example of an integration flow, user 102 may build an integration scenario that synchronizes data between an enterprise resource planning (ERP) system and a customer relationship management (CRM) system. Such an integration scenario may receive information about a new customer from the CRM system and insert that information into the ERP system to ensure that the two systems stay in synchronization. In this scenario, user 102 may add an asset in integration application design tool 110 that connects to the CRM system and add a second asset in integration application design tool 110 to connect to the ERP system. The resultant integration application may then receive a set of fields from the CRM node and pass these fields via the connection to the ERP system to add the new customer data in the appropriate format and/or through a suitable API.

In a second example of an integration flow, user 102 may build a health and fitness integration application. A first asset in such an integration scenario may connect to a user's watch to retrieve data about the number of steps, e.g., from a pedometer, taken in a day by the watch wearer. In this example, a second asset may record this data into a database server stored on the cloud for record keeping and analytic generation. One skilled in the relevant arts will appreciate that the first asset may include a variety of accessible data fields that may or may not correspond to the data fields used and/or otherwise available within the second asset.

Integration application design tool 110 may further allow user 102 to map fields from a first asset (the source asset) to fields of a second asset (the target asset). In other words, a first asset may use data that may be passed through to a second asset, and user 102 may specify on a field-by-field basis the appropriate association. To continue the exemplary pedometer example described above, consider an exemplary schema representing the fields in the source asset (the watch with a pedometer): StepDate: smalldatetime; NumberOfSteps: int. The second asset (the cloud-stored database server), could include a database table represented with the exemplary schema: RelevantDate: date; StepsTaken: big int; TotalDistance: decimal User 102 may select an appropriate mapping between the first asset and the second asset. User 102 may configure StepDate to link to RelevantDate and NumberOfSteps to link to StepsTaken, with TotalDistance remaining unlinked. By configuring the integration flow thusly, when the integration application executes, it may initialize the fields in the target asset and populate their values using the relevant fields from the source asset.

As described above, for less trivial cases (e.g., where the assets have more than the above two or three fields), this may be an extremely time consuming endeavor for user 102. For such cases, integration application design tool 110 may provide an auto-mapping recommendation, described in further detail below.

User interface components 112 may be employed by integration application design tool 110 to provide components used by integration application design tool 110 to render a user interface for view by user 102 via device 104. User interface components 112 may include a JavaScript user interface library to control dynamic interactions between user 102 and integration application design tool 110. User interface components 112 may include a development toolkit facilitating the building of HTML5 or mobile applications. User interface components 112 may allow a business or organization to upgrade components used by integration application design tool 110 in order to change the experience for user 102 over time.

Runtime components 114 may allow an integration application created via integration application design tool 110 to function at runtime. In one embodiment, runtime components 114 may build, assemble, compile, or otherwise create executable object code based on the specified integration scenario. In another embodiment, runtime components 114 may create interpreted code to be parsed and applied upon execution. Runtime components 114 may connect to ancillary systems to retrieve, store, and manipulate data using an appropriate API or other method. Runtime components 114 may include a variety of intermediary hardware and/or software that runs and processes the output of integration flows.

Auto-mapping recommender 116 may be leveraged by integration application design tool 110 to provide a suggested linking between fields in a source asset and fields in a target asset, i.e. an auto-mapping recommendation. Auto-mapping recommender 116 may deploy a neural network to determine appropriate mappings between a field in a source asset (i.e., the input layer) and a field in a target asset (i.e., the output layer) using a hidden layer and associated weights. Auto-mapping recommender 116 may train the neural network to provide more accurate recommendations over time based on user provided feedback, for example, corrections made by a user to the recommendation, a user acceptance of the recommendation, or a user rejection of the recommendation.

Auto-mapping recommender 116 may suggest mappings to user 102 in a graphical representation. Such a graphical representation may demonstrate connections between the fields of one asset to the fields of the second asset with lines, arrows, or other visual connectors. Auto-mapping recommender 116 may further translate recommended mappings into a script in an expression or scripting language. Such translation is advantageous because user 102 may view an alternate, textual form of the recommendation and make modifications therein. Moreover, the script may subsequently be executed at runtime to link the source fields and target fields. Additionally, the script may be updated, either manually by user 102 or by auto-mapping recommender 116, to perform additional data transformations. For example, a smalldatetime field may be translated to a date field, a long integer transformed into a floating point number, etc.

Data 117 may be any of a panoply of data storage systems housing information relevant to, used in, and stored by integration application design tool 110 including information about designed integration scenarios, available assets for deployment, connections, a neural network employed by auto-mapping recommender 116, etc. For instance, data 117 may be a database management system or relational database tool. Data 117 may further be a message queue or stream processing platform such as Apache Kafka or Apache Spark or other data storage systems like Apache Hadoop, HDFS, or Amazon S3, to name just some examples. Data 117 may be a data lake, data silo, semi-structured data system (CSV, logs, xml, etc.), unstructured data system, binary data repository, or other suitable repository. Data 117 may store thousands, millions, billions, or trillions (or more) of objects, rows, transactions, records, files, logs, etc. while allowing for the creation, modification, retrieval, archival, and management of this data. In an embodiment, data 117 uses scalable, distributed computing to efficiently catalog, sort, manipulate, and access stored data.

Semantic dictionary 119 may be used by auto-mapping recommender 116 and/or integration application design tool 110 to determine relationships between fields within source assets and the target assets. In one embodiment, semantic dictionary 119 may map words to other words exhibiting similar meaning. For example, a field name of “UserName” may be mapped in semantic dictionary 119 to a field name of “LoginName.” Thus, semantic dictionary 119 may allow auto-mapping recommender 116 to identify matches among fields in a manner exceeding mere syntactic equivalence. Semantic dictionary 119 may further include a linguistic corpus or additional annotations used to link field names between assets and to derive meaning from and make connections between the fields and across disparate assets.

Systems 120, such as system 120A, system 120B, and system 120C, may be an API, data source or other technical resource or system to be included in an integration flow. Systems 120 may house data in a number of fashions, such as in a suitable data repository, either in a raw form or following (or at an intermediate step within) the application of a transformational capability. Systems 120 may include data lakes, data silos, message streams, relational databases, semi-structured data (CSV, logs, xml, etc.), unstructured data, binary data (images, audio, video, etc.), or other suitable data types in appropriate repositories, both on-premises and on the cloud. Just for example, systems 120 may provide data or functionalities by connecting to a CRM system, an ERP system, a database, an internet-Of-Things device, a mobile phone, a watch, a JIRA task list, a revision control system or other code management tool, and/or a multitude of other sources.

In example embodiments, a bot may assist users with their integration development. In example embodiments, a user may be able to communicate to the both in natural language and/or low- or no-code development environments as well as to ask status of the integration involving a specific component of the enterprise software or other queries of the specific integration or the global systemic ramifications thereof. In example embodiments, a bot may identify the intent and redirect the user to the proper page. For example, if the bot determines the intent is to “create an integration,” the bot may redirect the user to the integration creation page. In example embodiments, the bot identifies parameters and automatically fill out data. For example, if a user says they want to build a “real time bidirectional” integration, the bot may automatically fill out the frequency and bidirectional fields on the integration form with the relevant values as discussed above with respect to FIGS. 5A-5D. In example embodiments, the bot may answer user questions about the meaning of questions or user inputs. For example, a user may ask what a bidirectional integration is, and the virtual developer may reply with an explanation.

Recommendation Engine: In example embodiments, a recommendation engine learns user behaviors and recommend next actions. Users are able to select these actions and be appropriately redirected. In example embodiments, when a user begins typing a value the system may automatically complete the text provided the model is sufficiently confident. In example embodiments, when brought to a form, the recommendation system may automatically populate values with best guesses provided the model is sufficiently confident. The recommendation may provide helpful links and documents for a given task when appropriate. This may assist the user in the development process with additional context.

Example embodiments include methods and systems for multi-modalities integration, i.e., unidirectional and bidirectional via any one or more of speech, chatbot, low code, and no code enterprise integration.

Over the past few decades, computer interfaces have continuously improved from text-based terminals to clunky desktop applications, and finally to responsive modern user interfaces (UIs). With the rise of machine learning and natural language processing, a new option has appeared as well, the new option being the conversational UI. With conversational UI, users communicate with a bot or computer program which guides users through a series of questions via natural language. Predecessors of conversational UI were effectively just primitive chat bots. Responses to questions needed to be stated according to rigid guidelines or else the computer would not process the request. With modern machine learning, it is far easier for computers to identify user intents from speech or text. This is essential for smooth UI due to the variety of human language.

Intent extraction is part of modern natural language processing and is particularly well-suited to the domain of software integration. This is because there are generally only a few things that need to be known to build a software integration: i) the source of the data (defects in Jira, table in ServiceNow, SQL column, etc.), ii) the target for the data (SQL database, a CRM system, etc.), the event in question in the source system (A bug was filed, a record was created, etc.), iii) the action that may be taken in the target system (Update a record, send an email, etc.), and iv) how often may the data move (real-time, hourly, daily, etc.).

With the answers to these questions, example embodiments build numerous integrations, robotic process automations, and business workflows. An example of this would be an integration to move incidents from ServiceNow to Jira. A user may say “I would like to open a bug in Jira for each urgent incident in ServiceNow in real time.” By doing so, a conversational agent may be configured to extract the source, target, event, action, and frequency of the integration, and set it up for the end user. In example embodiments, the source is ServiceNow, the target is Jira, the event is the “urgent incident,” the action is to open a bug, and the frequency is in real time.

In example embodiments, there may be more to building an integration than these five data points, and almost everything besides answering these questions can be handled by the system automatically. Once these answers are known, the software can automatically set up and deploy integrations to move the appropriate data. Likewise, additional software to monitor this integration for i) performance, iii) data integrity, and iii) data synchronization may also be automatically constructed and deployed.

Using machine language (ML) and Conversational ML in integrations—Example embodiments of the systems and methods include making use of language to enable integration without deep technical knowledge that is usually needed to effect enterprise software integrations. Natural language processing enables the ability to move from speech to text-based conversion. In addition, higher level language understanding is needed to enable useful dialog between natural language commands and the integration efforts. In order to effect these changes, the platform according to example embodiments makes use of intent and entity extraction and utilization.

Example embodiments make of intent-based ML to facilitate software integrations and hyper automation. An intent represents the purpose of a user's input. Example embodiments include a platform to map an intent for each type of user request to the API and applications supported. Coupling entity extraction in the natural language processing (NLP) of the invention enables a term or object that is relevant to your intents and that provides a specific context for an intent. In the platform according to example embodiments, example intents include adding connected systems and building or modifying integrations. The natural language interface can also be extended to allow users to query their data in addition to building integrations for their data. The ML used by the platform according to example embodiments makes use of an ensemble of deep neural networks and decision/dialogue tree models. At runtime, both the rules based decision tree and ML methods may be used simultaneously or contemporaneously, and a confidence score may be calculated for each based on previous user experiences. Whichever method returns a higher confidence may be used to select the appropriate response to the end user. In certain cases, the range of allowable responses may be so narrow that ML may not need to be used at all, and decision trees may be configured to provide the full suite of functionality.

Example embodiments can also enable mapping of intent to entities that may be pre-defined in the platform either by manual coding or by automated discovery or application programming interface (API) discovery process that can automatically map the functionality of the API along with the possible functional manipulations which are possible with given entities. The intent-matching step is the initial “fuzzy” step, where the bot attempts to understand what the user is trying to do in general. Example intents include adding connected systems and building or modifying integrations. Each intent may have a desired or predetermined parameters associated therewith, which the bot attempts to identify by prompting the user(s) for the specific values of each parameter (slot filling). When possible, machine learning is used during slot filling to avoid a user having to memorize specific terms or vocabulary. If the parameters are expressed in the initial intent, the bot may be configured to directly extract them and avoid the need for additional prompts. For example, a user may state they want to build an integration and also detail many of the specifics of that integration in a single utterance.

A greater discussion on machine language is discussed herein. Machine language systems and methods for building software applications may include a knowledge base, an application scenario player, a service connector, presentation components, and underlying system component-services. In example embodiments, instead of using “almost natural language,” users can communicate directly in natural language with the platform. In example embodiments, the integration and use of speech affords the opportunity for the speech to interact simultaneously or contemporaneously with integrations and a systematic, orchestrated integration service that can contain dedicated code both on a macro level, i.e., for all systems involved via, for example, the cloud, as well as the individual enterprise software level and on-premise level. Furthermore, the system affords a dynamic query capability of all of these systems for question and answer and escalation of these questions to a ticketed system to enable human intervention if and when needed. Example embodiments create an agnostic speech interface for inclusion of different third-party, and/or more specialized bots, as well as integration of different code or low-code systems. Example embodiments provide added flexibility due to the use of speech to interrogate the actual end-user data itself and its ability to work with a wide range of application APIs that can be auto-discovered and exposed to the speech/bot interface. In example embodiments, the controlled vocabulary and use of ML allows to refine the relationship between intent and entity extraction on an aggregate basis, e.g. to optimize both a single tenant system or globally using these insights across all systems, as well as enhance individual profiles by learning from integration success and proxies for success, sentiment analysis of communications and human-based training and audit review.

In example embodiments, technology which can be utilized in the platform according to example embodiments may include, e.g., Google Dialogflow. Dialogflow is an end-to-end, “build-once deploy-everywhere” development suite for creating conversational interfaces for websites, mobile applications, popular messaging platforms, and IoT devices.

Predictive analytics to optimize integrations—Example embodiments include the use of algorithmic and predictive integration to enable systematic integration. While the programmatic features of the system afford the ability to directly integrate using the APIs of the various enterprise software systems, there is also the opportunity to make use of the software driven integration platform that the invention can enable. Example embodiments provides a software-based integration platform that both contains a rule-based integration decision tree which can provide higher likelihood of successful integrations without violation of methods and connectivity which result in invalid data flow as well as systematic methods of monitoring for software error ‘codes’ from either the enterprise software or the inventive integrative platform. In addition, the platform can perform tests to validate proper data integration as well as running preventive and workflow diagnostics to provide use case and test case based testing.

In example embodiments, predictive analytics can be provided that adapts and optimizes changes in when updates or changes occur in one system, integration changes are automatically adjusted to accommodate these changes without need for human intervention. Such predictive analytics can be a combination of a hierarchical rule-based system and/or machine learning system that affords insights that can be either directly translated into integration changes or offered to the end-user as recommendations or alerts to consider before or after making a change in the integration.

System Awareness through the use of Domain Specific Chatbots—Alternatively, the platform can make use of specialized Chatbots that have domain specific language and algorithms that are specific for particular tasks and/or particular enterprise systems.

Recommendations and demonstration of different code paths—Example embodiments may learn from the selected option selections as well as feedback from the system (including violation notices, analytics, measures of data integrity) to better recommend these suggestions to individual users and organizations. This capability is aimed to provide many of the fields entered and options selected in the system.

The platform according to example embodiments also makes use of macro information, meta-data and other data sourcing (including aggregate user data, single tenant specific and end-user data) in creating recommendations. Example embodiments can also effectively create a hierarchy of chatbots in at least the following ways:
1. Integrating with external chatbots: Integrated systems may contain chatbots or be chatbot systems, in which case the platform can redirect users to specific chatbots when appropriate based on the user's context.
2. Exposing APIs as chatbots: The system may be configured to expose discovered APIs as chatbots. For any given API, there is a set of required and optional fields. When combined with the context of the purpose of each API, the platform may be configured to generate a unique chat experience for each connected API, even if those APIs do not normally have chatbots associated with them.
3. Custom Bots: End users may be able to create custom bots using the low/no-code and conversational interfaces by creating questions, intents, and slots. The system may be configured to forward user from bot to bot as needed, combining all of their capabilities to enrich the user experience.

Extracting Analytics Workflows using Conversational artificial intelligence (AI)—The platform according to example embodiments can also provide bi-directional insights/communication through automated testing, recommendations and other data that is informed by system status and analysis of meta-data that is generated from the platform according to example embodiments and the enterprise use. The platform according to example embodiments, is also configured to show analytics workflows both of the platform itself as well as the constituent enterprise software packages that make up the integrated system of an organization.

The platform according to example embodiments can also serve to provide the following functionality: i) Automated testing of workflows and end-point confirmation analysis; ii) Performance monitoring and data synchronization; iii) Field level mapping recommendations—based on prior integrations, integration logic, feedback from customers on integration success—based on pre-programmed intent-based logic, taxonomy and rule-based algorithms; iv) Q&A for common user questions.

In example embodiments, smart integration may include automatically performed tasks, or tasks performed based on a given environment such as, e.g., automatically updating workflows and automatically updating various services such as email and the like.

In example embodiments, the system may learn from the selected options to better recommend them to individual users and organizations. This may be the case for the majority of fields entered and options selected in the system.

Permissions and Recommendations: Different users of a given instance of the system can have different permissions. For example, platform owners may choose to let all users be able to integrate with ServiceNow, but only let some integrate with S3. In addition, he recommendation engine is configured to learn individual user and organizational behavior to power recommendations. Block-chain is configured to record in a ledger the different permissions and individual integrations of each user in the system.

In example embodiments, updates to the platform, or other platform changes, may be performed inside the connected systems. In embodiments, applications can be built inside connected services using a dialog box such as discussed above with respect to FIGS. 5A-5D. For example, the method may include building a ServiceNow application inside of a connected ServiceNow service. The following is a greater discussion on workflow generation.

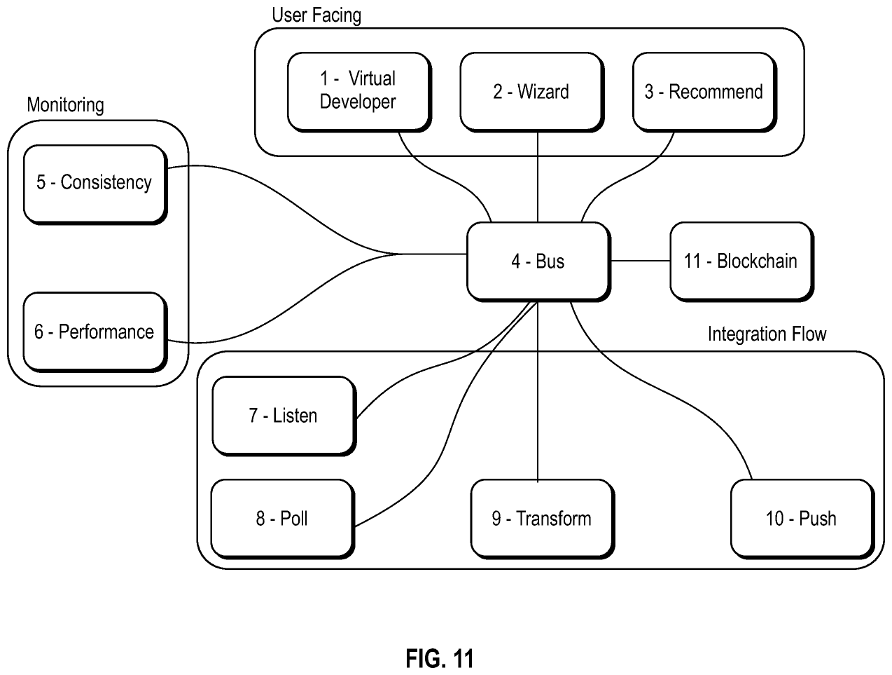

FIG. 11 is a diagram illustrating operation of integrated services according to various example embodiments. The services according to various example embodiments may be described in belonging to three (3) categories: 1) User-Facing services, 2) Monitoring services, and 3) Integration services.

In example embodiments, the User-Facing services include a Virtual Developer 1, a Wizard 2 and a Recommender 3 all connected via a Bus 4. The Virtual Developer 1 includes a ML- and AI-powered NLP bot configured to answer user questions, fill out forms, and build integrations and bots on behalf of the users. The Virtual Developer 1 may respond to user requests and may automatically configure records according to the user's natural language requests. In example embodiments, the Wizard 2, or low-code integration builder service, may be leveraged by end users to construct new integrations and robotic process automations (RPAs). The Wizard 2 may include a serverless front end and an operational data store, and may store configurations made by users through either the Virtual Developer 1 or the low-code interfaces. In example embodiments, the Recommender 3 is configured to observe user behavior and to recommend appropriate next actions leveraging deep learning technologies. The Recommender 3 may leverage sentiment analysis to ensure that users are having an optimal experience. The Recommender 3 may reach out to multiple different NLP services in order to obtain the most accurate predictions for any scenario. The Virtual Developer 1, Wizard 2, and Recommender 3 may all share information to stay in sync with respect to user inputs.

In example embodiments, the Bus 4, or Event Bus 4, is configured to organize traffic between the different services, i.e., between the User-Facing services, the Monitoring services, and the Integration services.

In example embodiments, the Monitoring services include a Data Integrity service 5 and a Performance Monitoring service 6. In embodiments, the Data Integrity service 5 may periodically check systems for anomalous updates, and may handle them appropriately. Users may be able to choose to let the errors be auto-corrected, or to manually handle the errors. The Data Integrity service 5 may also notify end users of any issues that may arise with respect to the integrity of the data. In embodiments, the Performance Monitoring service 6 may monitor transactions to identify increases in latency or system crashes. Once these issues are identified, the Performance Monitoring service 6 may alert other services to, e.g., slow down in order to preserve performance. Should the latency vanish, the Performance Monitoring service 6 may alert other services that it is safe to continue operation at normal loads. In the event of external system crashes, the Performance Monitoring service 6 may alert other systems to temporarily pause their attempts to communicate with the crashed system until it is safe to restart them.

In example embodiments, the Integration services include a Listening service 7 configured to monitor traffic for incoming events. Depending on which integration they want the data to initiate, different endpoints may be flagged on the Listening service 7. In embodiments, the Integration services may include a Polling service 8 configured to regularly check external systems for updates and events. The Polling service 8 may achieve this by starting multiple processes to make the appropriate request types, such as rest, soap, or Java Database Connectivity (JDBC). In embodiments, the Integration services may include a Transformation service 9 configured to transform event data to be suitable for a user's desired action. The transformation process is handled by the Transformation service 9, which is configured to convert files from one type to another according to the mapping logic automatically configured by the system or manually configured by the user. In embodiments, the Integration services may also include a Pushing service 10 which, once data is ready to be sent, makes requests to external systems to perform the actions specified by the relevant integrations. This is accomplished, in example embodiments, through multiple parallel processes configured to make the appropriate request types to external systems.

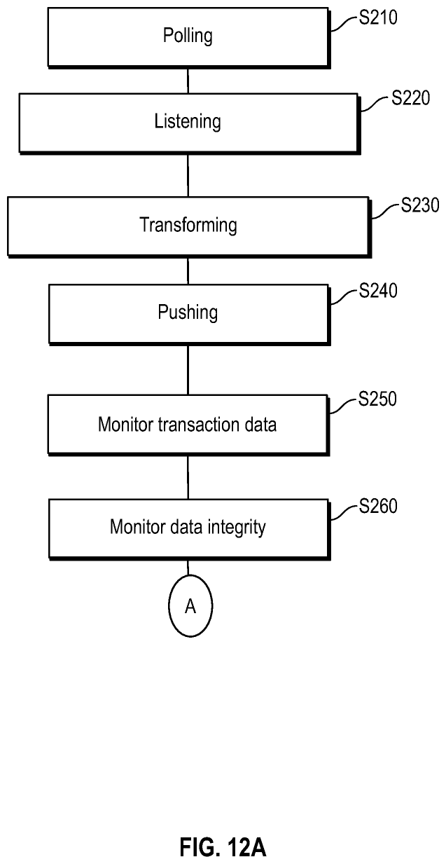

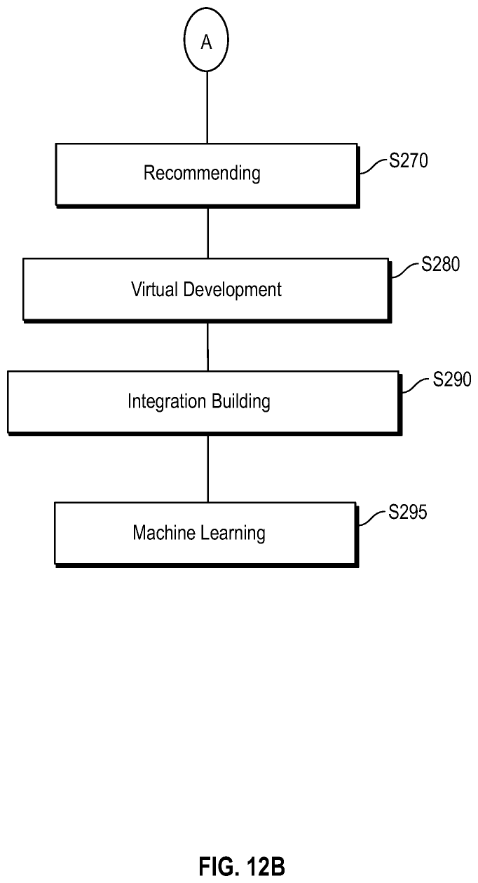

In example embodiments, the User-Facing services, the Monitoring services, and the Integration services may be connected to a Blockchain Ledger 11, where transactions from the Integration services discussed above may be persisted to the Blockchain Ledger 11 to provide a distributed transaction storage. Such persistence may provide a higher degree of immutability and may allow end users to control their data. A description of the flow of the above services is provided below with respect to FIGS. 12A-12B.

FIGS. 12A-12B are flowcharts describing a plurality of services performed as part of an integration process, according to various example embodiments. In FIG. 12A, the method may perform polling at step S210. In example embodiments, the polling service may regularly check external systems for updates and events. The method may also perform listening at step S220. In example embodiments, some systems, such as those using webhooks, may choose to push events instead of having them polled. For these systems, a listening service is installed which monitors traffic for incoming events. The method may further perform transforming at step S230. In example embodiments, the event data may be transformed to be suitable for the action. This transformation process is handled by a transformation microservice.

In FIG. 12A, the method may perform pushing at step S240. Once data is ready to send, a pushing microservice makes requests to external systems to perform the actions specified by the relevant integrations. The method may also monitor performance at step S250. In example embodiments, a performance monitoring service watches transactions to identify increases in latency or system crashes. Once identified, the service alerts other services to slow down in order to preserve performance. If the latency vanish, the service may alert others that it is safe to continue at normal loads. The method may further monitor data integrity at step S260. In example embodiments, a data integrity service may periodically check systems for anomalous updates and handle them appropriately. Users are able to choose to let the errors be auto corrected or manually handled. In addition, the system may notify end users of issues.

In FIG. 12B, the method may perform recommendations at step S270. In example embodiments, a recommendation service may observe use behavior and recommend appropriate next actions leveraging deep learning technologies. The recommendation service may leverage sentiment analysis to ensure users are having an optimal experience. The method may also perform virtual development at step S280. In example embodiments, a bot responds to user requests and automatically configure records according to the users ‘natural language requests. The method may further perform integration building at step S290. In example embodiments, the integration builder service is leveraged by end users to construct new integrations out of connected systems, events, and actions. The method may also use machine learning at step S295. In example embodiments, the system may host its own machine learning algorithms to power the recommendation engine and virtual developer and also reach out to external machine learning commodities to enhance performance. In example embodiments, through the event log and immutable blockchain ledger, the system may also be configured to service as a source of truth for audits and data integrity purposes. In example embodiments, through the previously detailed data integrity and performance

monitoring services, the system may be configured to identify and correct performance and data issues as they occur, eliminating the need for manual intervention. In example embodiments, for security purposes, the system may be single tenant and multi instance. Each customer may have their own version of the system to use, which contains their own data.

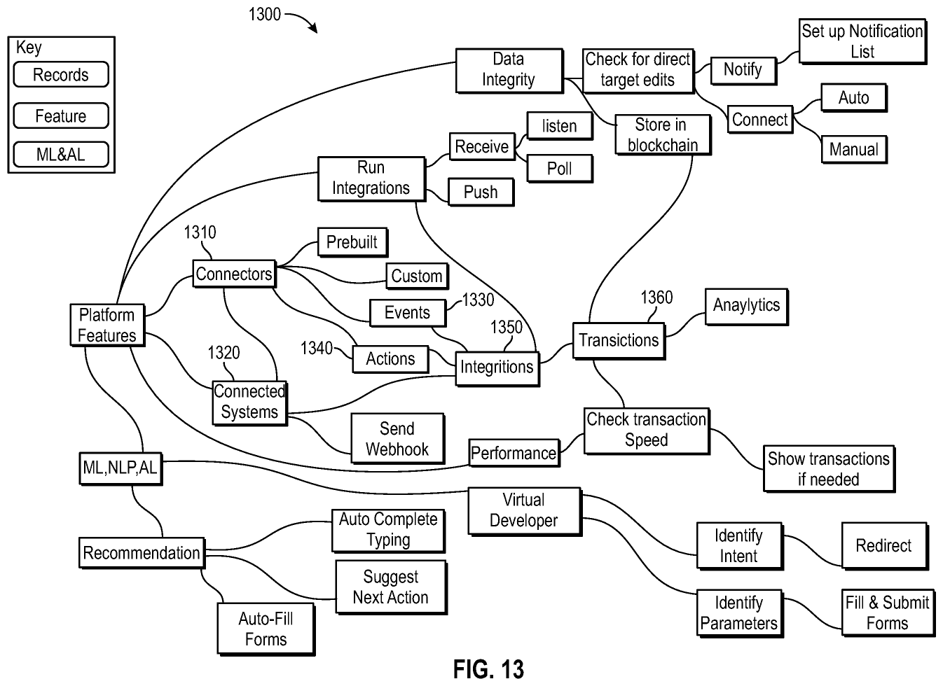

FIG. 13 is an illustration of a platform for software integration in accordance with example embodiments. In example embodiments, the platform 1300 includes connectors 1310. In example embodiments, the connectors 1310 may be prebuilt bundles of software configured to facilitate integrations with a specific system, bot, or application. For example, the system may have ServiceNow connectors, Jira connectors, MySQL connectors, and the like. In embodiments the system may support both pre-built and custom connectors. Each connector may be configured to be associated to events and actions. In example embodiments, the platform 1300 also includes connected systems 1320. In example embodiments, the connected systems 1320 may include instances of individual connectors. For example, the platform 1300 may use a MySQL connector to integrate with three (3) different databases. In this example, the users can choose if each connected system will monitor the same events/actions or different ones. In embodiments, each of the connections would constitute a separate connected system 1320. In embodiments, to create a connected system 1320, users may enter the details required to locate the platform 1300 (such as its URL), as well as any required authentication details. In example embodiments, the platform 1300 may further include events 1330.

In example embodiments, the events 1330 may include events that happen in external systems and that cause integrations to start, such as, e.g., the updating of a record, or the sending of an email. In example embodiments, the platform 1300 may include actions 1340. In example embodiments, the actions 1340 may include action items that should be performed in connected systems, such as, e.g., creating records, or modifying user profiles. In example embodiments, the platform 1300 may further include integrations 1350. In example embodiments, the integrations 1350 may include combinations of events and actions. In embodiments, each integration may or include as a sentence with, e.g., the following structure: When EVENT happens, perform ACTION. For example, when User updates a record in Jira, update it in ServiceNow. More complex integrations may be created by combining multiple events and actions together. In example embodiments, the platform 1300 may further include transactions 1360. In example embodiments, the transactions 1360 may include data changes that move through the integration platform between e.g., connected services. In embodiments, a transaction may be a created user, a sent email, or an updated record. Reporting and analytics may be available for transactions, and may be stored in blockchain ledgers.

FIG. 14 is a functional block diagram of an example network architecture including an example artificial intelligence (AI)-based conversational querying (CQ) platform, according to example embodiments. FIG. 14 is a functional block diagram illustrating example network architecture 100 configured to provide querying of one or more content sources 128 via an automated interactive conversational environment, according to example embodiments. Network architecture 100 may include conversational querying (CQ) platform 1002, client device 108 associated with user 106, administrator console 1161 associated with administrator (admin) 1114, at least one live agent server 1200 associated with live agent 118, analytics server 122 and one or more content sources 128. Each of CQ platform 1002, client device 108, administrator console 1161, live agent server 1200, analytics server 122 and content source(s) 128 may comprise one or more computing devices, including a non-transitory memory storing computer-readable instructions executable by a processing device to perform the functions described herein.

Although the description herein describes network architecture 100 having one client device 108 and one administrator console 1161, in some examples, network architecture 100 may include one or more client devices 108 and/or may include one or more administrator consoles 116. Moreover, although the description herein describes network architecture 100 having one live agent 118 in communication with one live agent server 1200, in some examples, network architecture 100 may include one or more live agents 118 and/or one or more live agent servers 120. In some examples, live agent 118 may communicate with live agent server 1200 directly. In some examples, live agent 118 may communicate with live agent server 1200 via a separate computing device (not shown), such as a desktop computer, a laptop, a smartphone, tablet, a live agent console device or any other computing device known in the art that is configured to communicate with live agent server 1200 and client device 108.

CQ platform 1002, client device 108, administrator console 1161, live agent server 1200, analytics server 122 and content source(s) 128 may be communicatively coupled via at least one network 1041. Network 1041 may include, for example, a private network (e.g., a local area network (LAN), a wide area network (WAN), intranet, etc.) and/or a public network (e.g., the internet). In general, CQ platform 1002 may provide server-side functionality via network 1041 to user 106 associated with client device 108.

Client device 108 may comprise, without being limited to, a desktop computer, a laptop, a notebook computer, a smartphone, a mobile phone, a tablet, a portable digital assistant (PDA), a multi-processor system, a microprocessor-based or programmable consumer electronic device, or any other communication device that user 106 may utilize to interact with CQ platform 1002, content source(s) 128 and live agent server 1200. User 106 may interact with client device 108, for example, via a graphical user interface (not shown) displayed on any type of display device including, without being limited to a computer monitor, a smart-phone or mobile phone screen, tablet, a laptop screen, a consumer device screen or any other device providing information to user 106. In general, client device 108 may include any suitable user interface, user input component(s), output component(s), and communication component(s) for interaction with CQ platform 1002, live agent server 1200 and websites having one or more web pages (including, in some examples, websites among content source(s) 128).

Client device 108 may include web client 1101 (e.g., a browser, such as the Internet Explorer™ browser developed by Microsoft™ Corporation and one or more Client applications 113. Client applications 113 may include a web browser, a messaging application, electronic mail (email) application, and the like.

While the client-server-based network architecture 100 shown in FIG. 14 employs a client-server architecture, the present disclosure is of course not limited to such an architecture, and could equally well find application in a distributed, peer-to-peer, architecture system, or any other networked environment. Further, in some examples, the network architecture 100 may be deployed using a virtual private cloud including, for example, frontend sever(s), backend server(s), and database server(s) in the cloud.

Administrator console 1161 may comprise, without being limited to, a desktop computer, a laptop, a notebook computer, a smartphone, a mobile phone, a tablet, a portable digital assistant (PDA), a multi-processor system, a microprocessor-based or programmable consumer electronic device, or any other communication device that administrator 1114 may utilize to interact with CQ platform 1002 and analytics server 122. Administrator 1114 may interact with administrator console 1161, via a graphical user interface (not shown) displayed on any type of display device. Administrator 1114, via administrator console 1161, may be configured to interact with intent analysis system 136 of CQ platform 1002, such as for training of intent analysis system 136. Administrator 1114, via administrator console 1161, may also be configured to interact with analytics server 122, such as for analysis of the performance of CQ platform 1002 with various users.

Live agent server 1200 may be configured to communicatively connect user 106 associated with client device 108 with live agent 118, for human interaction with live agent 118 via a live chat. In general, live agent server 1200 may receive a request from CQ platform 1002 to initiate a live chat between user 106 of client device 108 and a live agent among live agent(s) 118 associated with live agent server 1200. The request for a live chat may include user information (e.g., user name, email address, internet protocol (IP) address, etc.), information regarding a type of service requested for the live chat (e.g., service related to an account, purchasing, pending orders, technical questions, etc.) and a history of automated conversational querying between user 106 and CQ platform 1002. In some examples, the type of service requested may be associated with different agents 118. For example, an account type service may be assigned to a first live agent (such as a customer support expert) and a technical question service may be assigned to a different, second live agent (such as a technical support expert). Live agent server 1200 may identify a suitable live agent 118 based on the information received in the request for live chat from CQ platform 1002, and may initiate connection between the selected live agent 118 and client device 108.

As discussed further below, chat bot 132 of CQ platform 1002 may generate an instance of a chat bot interface 150 on one or more websites displayed on client device 108 (e.g., via web client 1101). Chat bot interface 150 (also referred to herein as bot interface 150) may include an option for user 106 to request to chat with live agent 118 (e.g., by selecting a ‘Contact Support’ option in a selectable menu on chat bot interface 150). Chat bot interface 150 may allow user 106 to contact live agent 118 directly without navigating to any other applications, web pages or websites. In some examples, CQ platform 1002 may automatically suggest contact with live agent 118, through chat bot interface 150, based upon user input during automated conversational querying and/or through monitoring user actions on website(s). For example, chat bot interface 150 may provide a contact support option when a query asked by user 106 is unable to be answered by CQ platform 1002 or answered with a confidence below a predetermined threshold. Responsive to user selection of a live chat option (via chat bot interface 150), CQ platform 1002 may generate and send a request to initiate a live chat to live agent server 1200.

In addition to initiating a connection between live agent 118 and client device 108, live agent server 1200 may be configured to generate a live agent console display for the selected live agent 118 (e.g., on live agent server 1200 or on a computing device connected to live agent server 1200). Live agent console display 1500 may be configured to display information related to the user (including information in the received request), generally illustrated as user information region 1502. Live agent console display 1500 may also provide live agent 118 the ability to access to additional information from among content source(s) 128 for responding to user 106. Live agent console display 1500 may also provide an interface for live agent to chat with user 106, generally illustrated as chat area 1504. In general, a live agent console display may provide suitable information and data in one or more interactive windows to allow live agent 118 to communicate and provide information to user 106.

Live agent server 1200 may also be configured to provide the live chat between live agent 118 and client device 1101 via chat bot 132, through chat bot interface 150. Thus, upon user selection of a live chat option (by user 106) and selection of live agent 118 (via live agent server 1200), chat bot interface 150 may display the available (selected) agent, and user 106 may start chatting with live agent 118 through chat bot interface 150. In some examples, live agent 118 may transfer the live chat to a different live agent, for example, via live agent console display 1500. For example, the first live agent 118 may be a customer service expert, and may determine that user 106 has a technical question that may be better answered by a second live agent that is a technical service expert. The first live agent may contact the second live agent via live agent server 1200, transfer information associated with the user during the live chat (e.g., information displayed on live agent console display 1500) to the second live agent, and transfer the connection to client device 108 from the first live agent to the second live agent.

Because the live chat is provided via chat bot 132 of CQ platform 1002, CQ platform 1002 may continue to monitor user communications and update its records during the live chat. Such monitoring may allow CQ platform 1002 to update its algorithms for automated conversational querying, to reduce instances of handoff to live agent server 1200. Such monitoring may also allow CQ platform 1002 to provide a seamless transition from the live chat with live agent 118 to automated conversation with internet 132.

In a non-limiting example embodiment, CQ platform 1002 may be configured to communicate with live agent server 1200 using one or more rest application program interfaces (APIs). In some examples, rest API(s) may be exposed by live agent server 1200 to check for agent availability, to start and end a live chat, to send and receive messages, etc. In some examples, CQ platform 1002 may use a live chat application, including a cloud-based application.

Analytics server 122 may be configured to receive data collected by CQ platform 1002 (e.g., user input, user request data, response data generated by CQ platform 1002, conversation details of automated conversations with chat bot 132, live chat with live agent 118), and may generate one or more metrics based on the received data. Analytics server 122 may include dashboard 124 configured to display generated metrics and data lake 126 for storing the received data.

Data lake 126 may be configured to store, for example, information and data collected from CQ platform 1002 relating to automated chats (i.e., via chat bot 132) and live agent chats (i.e., via live agent 118). The information may include, for example, conversational details (e.g., one or more user inputs, one or more user intents identified by CQ platform 1002, one or more query results obtained by CQ platform 1002) over one or more automated conversations and/or live chats with one or more users. In some examples, the collected information may also include user actions on one or more websites during automated and/or live chat conversations. The collected information may also include, in some examples, feedback from user 106 (received, e.g., via client device 108 and/or via chat bot 132) relating to CQ platform 1002. In some examples, the collected information may also include messages from client device 108 directed to live agent server 1200. In general, data lake 126 may be configured to store data/information of any size, shape and speed. Data lake 126 may include a database or datastore that stores a massive scale and variety of data in its native raw state and/or in an interpreted state. For example, as CQ platform 1002 generates raw data, that raw data may be stored within data lake 126 for later consumption, use, or interpretation by analytics server 122. Data lake 126 may include multiple separate databases and/or datastores that together make up data lake 126, or data lake 126 may be a singular datastore.

Dashboard 124 may be configured to provide an interactive user interface (e.g., for display on a display device) for displaying various metrics associated with the collected information/data stored in data lake 126.

In some examples, analytics server 122 may include a structured query language (SQL) server for managing and processing the information/data stored in data lake 126. In general, analytics server 122 may be configured to process and analyze the stored information/data across various platforms and various languages. Analytics server 122 may include an analytics module (not shown) for creating dashboard 124.

Content source(s) 128 may be embodied on one or more computing devices housed in one or more related or independent facilities that are configured to include information/data that may be useful to user 106. Some content source(s) 128 may store information associated with user 106 (e.g., account information). Other content sources(s) may include information unrelated to user 106 (e.g., a website associated with electronics distribution). In general, content source(s) 128 may include one or more of databases, servers, websites (having one or more web pages), applications, online communities, blogs, news sites, electronic journals, social networks, etc. Content source(s) 128 may include public resources and private resources.

In one example embodiment, content source(s) 128 may include one or more of product database(s), order database(s), account databases, and one or more online communities. CQ platform 1002 may include web channel 130, chat bot 132, message controller 134, intent analysis system 136, query system 138, one or more databases 140, administrator (admin) portal 142, web server 144, API server 146 and, optionally, authentication server 148. Although not shown, one or more of components of CQ platform 1002 may be coupled with a data and control bus. It may be appreciated that, in some examples, one or more components of CQ platform 1002 may be distributed across one or more locations (e.g., such as across one or more virtual machines (VMs)) and may be communicatively connected via one or more networks (not shown).

In general, CQ platform 1002 may be configured to interface with client device 108, to provide an automated conversational querying interface (i.e., a chat bot interface) for communicating with user 106 to identify querying intents and to provide results of querying to user 106. CQ platform 1002 may be configured to interface with content sources(s) 128, to retrieve relevant content for a query based on the identified intent and configure the results for presentation to client device 108. CQ platform 1002 may also be configured to interface with live agent server 128, to initiate and provide live agent chat to client device via live agent 118, retrieve relevant content for a query based on the identified intent and configure the results for presentation to client device 108. CQ platform 1002 may also be configured to interface with analytics server 122, to provide conversational detail information/data for further analysis.

Although FIG. 14 illustrates live agent server 1200 and analytics server 122 as being separate from CQ platform 1002, in some examples, live agent server 1200 and/or analytics server 122 may be configured to be part of CQ platform 1002. In some examples, integration of live agent server 1200 and/or analytics server 122 into CQ platform 1002 may improve the ability of CQ platform 1002 to manage data flow, storage and processing of data/information via the components of CQ platform 1002, for improved operation of CQ platform 1002.

In some examples, CQ platform 1002 may be configured as a cloud-based platform comprising one or more virtual machines, with the ability to scale the number of virtual machines based on a current load (e.g., application usage) on CQ platform 1002. In this manner, CQ platform 1002 may ensure optimum resource utilization, and CQ platform 1002 may easily scale up or scale out its resources as the application usage grows. In some examples, CQ platform 1002 may be configured to support Infrastructure as a Service (IaaS) cloud computing service.

Web channel 130 may be configured to provide web chat control for CQ platform 1002, to enable communication between chat bot 132 and client application(s) 113 of client device 108. Web channel 130 may include one or more APIs (such as DirectLine API) that may be exposed, for example, to start a conversation, send a message, receive a message etc.

In an example embodiment, a client component of web channel 130 may include a hypertext markup language (HTML) file with JS and CSS files included in a website associated with CQ platform 1002 (referred to as the platform website). The JS and CSS files may be included in the platform web site (avnet.com/huckster.io/element14.com) in an HTML iframe to enable chat bot 132 in the website. Based on the target website, the styling may be changed but all of the JS/CSS files may connect to the same instance of chat bot 134 deployed by CQ platform 1002.

Chat bot 132 may include an artificial intelligence (AI) (e.g., machine learning) engine configured to conduct an automated conversation with user 106 via text-based communication such as text messages in a chat interface. CQ platform 1002, via chat bot 132, may be configured to handle at least an initial portion of a query session with user 106, for example, to determine an intent for the query, so that user 106 may be properly routed to live agent 118 to handle the intent. In other cases, CQ platform 1002, via chat bot 132, may provide sufficient information or resolution to user 106 without involving live agent 118. In some cases, AI-generated content segments may be distributed throughout a chat session.

Chat bot 132 may be configured to generate chat bot interface 150 on web page(s) of one or more websites, for providing an automated conversational chat session with user 106. In an example embodiment, chat bot 132 may be configured as a plug-n-play model, such that chat bot 132 may be plugged into any web page, by including an <iframe> within a <div> of an HTML document. Chat bot 132 may be configured to manage a conversation using one or more dialogs. Each chat with chat bot 132 may be associated with a conversation identifier (e.g., ConversationID). When a user initiates a chat with chat bot 132, a ConversationID may be generated. The ConversationID may be used to maintain a chat history across various websites. Chat bot 132 may be configured to read and analyze user input via chat bot interface 150, and generate conversational answer(s) to the user input, by further processing via intent analysis system 136 and query system 138.

Message controller 134 may be configured to direct messages between client device 108 and internet bot 132. Message controller 134 may post messages to internet bot 132 (from CQ platform 1002) and may obtain messages from internet bot 132 (from chat interface 150). Message controller 134 may also be configured to direct messages received from internet bot 132 to intent analysis system 136.

Intent analysis system 136 may be configured to receive a message including user input from message controller 134. Intent analysis system 136 may be configured to identify an intent and entity(s) from the user input. Intent analysis system 136 may transmit the identified intent and entity(s) to query system 138.

Query system 138 may be configured to receive the identified intent and entity(s) from message intent analysis system 136. Based on the intent/entity(s), query system 138 may be configured to determine whether to perform an automated search or to initiate handoff of communication to live agent server 1200. Query system 138 may also be configured to perform an automated search of relevant content among content source(s) 128 upon a determination to proceed with the automated search. Query system 138 may also be configured to format any search results for display on chat bot interface 150.

Database(s) 140 may be configured to store automated chat conversation dialog for a conversation session. In some examples, database(s) 140 may store state data related to the conversation dialog (e.g., ConversationID, user selections, web page/website information, user actions on a web page during the conversation session, etc.) In some examples, database(s) 140 may store conversation dialog for a live agent chat during the conversation session, as well as any suitable state data. In some examples, database(s) 140 may include a NoSQL database (e.g., a non-relational or not only relational) database, such as a multi-model NoSQL database. In other examples, database(s) 140 may include a relational database (e.g., a SQL database).

Admin portal 142 may be configured as an interface for communication between admin console 1161 and one or more components of CQ platform 1002, including intent analysis system 136. Administrator 1114 may interact with one or more components of CQ platform via admin portal 142, for example to adjust parameters of intent analysis system (or other components) for identifying intents from user input.

Web server 144 may be configured to interface with client device 108 via web client 1101. API server 146 may be configured to interface with content source(s) 128 and live agent server 1200 via one or more APIs.

CQ platform 1002 may, optionally, include authentication server 148. Authentication 148 may be configured to authenticate user 106, to enable user 106 to interact with CQ platform 1002. In some examples, CQ platform 148 may request that user 106 register with CQ platform 1002 prior to initiating chat bot interface 150, the first time user 106 visits the platform website. CQ platform 148 may store the user information in database(s) 140 (for example) upon registration, such as user identity, email, account information, etc.

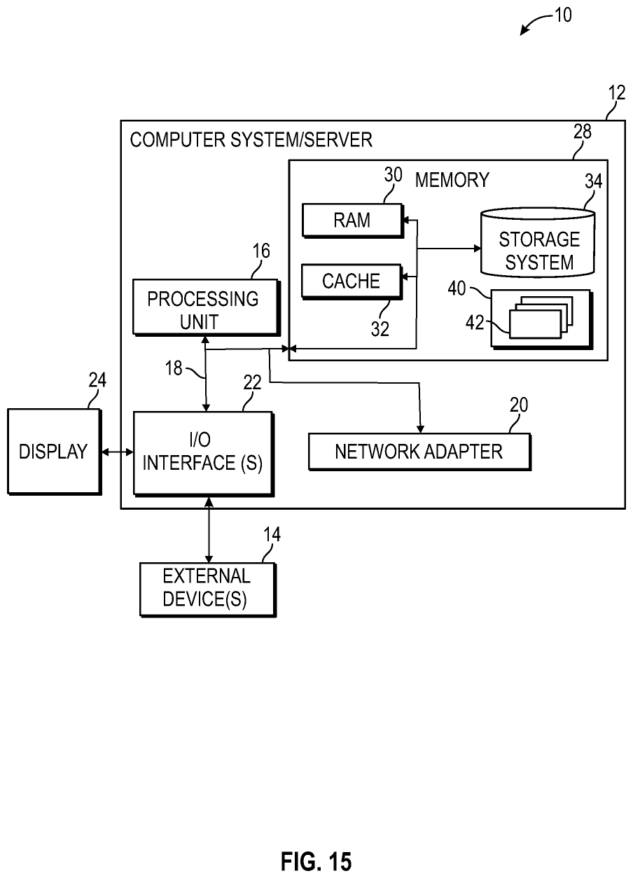

FIG. 15 illustrates a cloud computing node, according to example embodiments. In FIG. 15, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 15, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

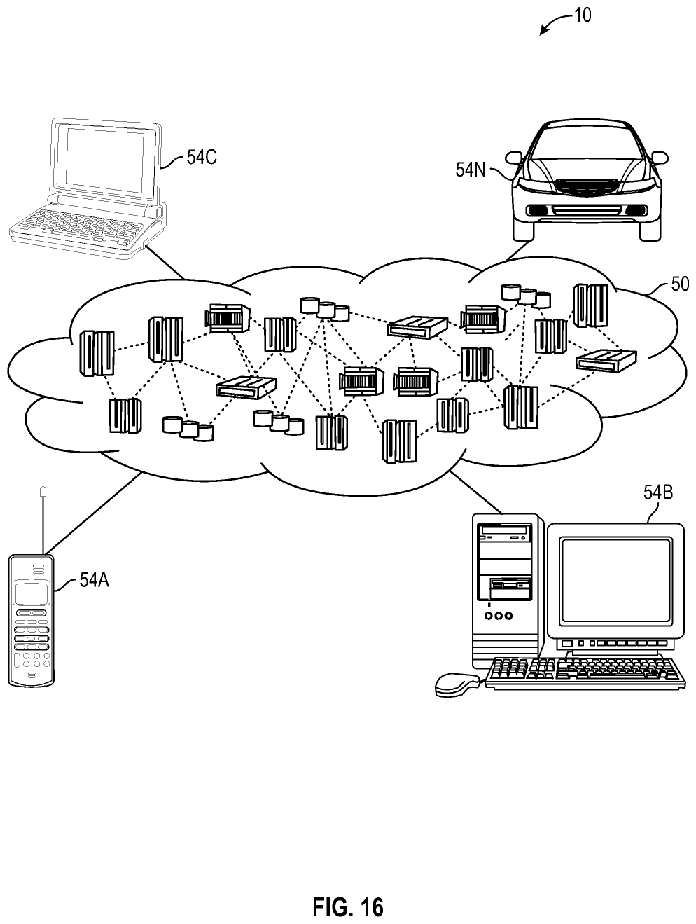

Referring now to FIG. 16, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 16 are intended to be illustrative only and that computing nodes 10 and cloud computing environment 50 can communicate with any type of computerized device over any type of network and/or network addressable connection (e.g., using a web browser).

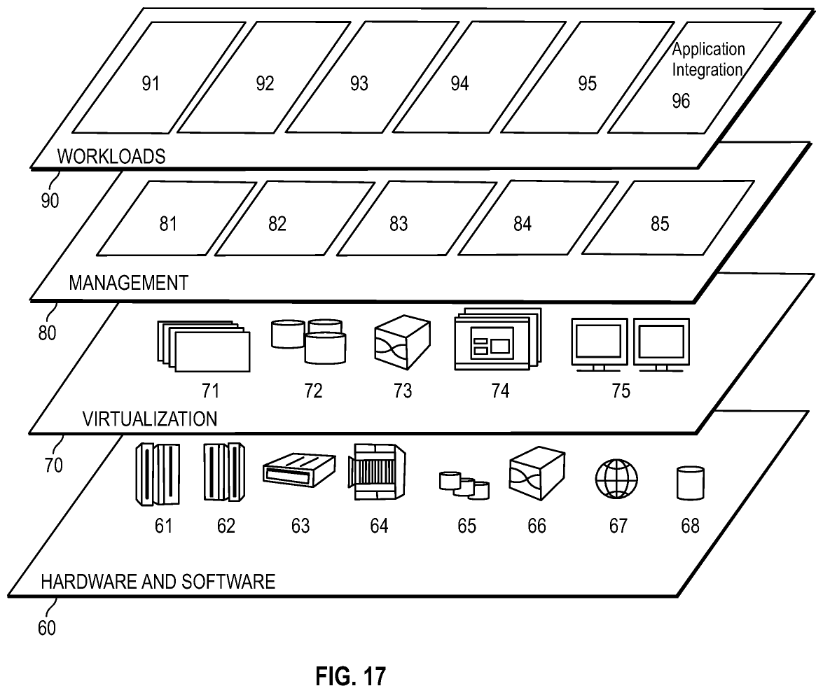

Referring now to FIG. 17, a set of functional abstraction layers provided by cloud computing environment 50 (FIG. 16) is shown. It should be understood in advance that the components, layers, and functions shown in FIG. 17 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and application integration 96.

Implementations of the invention may include a computer system/server 12 of FIG. 15 in which one or more of the program modules 42 are configured to perform (or cause the computer system/server 12 to perform) one of more functions of the application integration 96 of FIG. 17. For example, the one or more of the program modules 42 may be configured to: store one or more service connectors configured to connect a software system to another software system in the data repository, receive integration instructions, the integration instructions including at least one of an origin software system, a directionality of the integration, the directionality indicating whether the integration is unidirectional or bidirectional, a frequency of integration and a target software system, and perform the integration using the one or more service connectors according to the integration instructions.

While example embodiments have been described in conjunction with the example features outlined above, various alternatives, modifications, variations, improvements, and/or substantial equivalents, whether known or that are or may be presently unforeseen, may become apparent to those having at least ordinary skill in the art. Accordingly, the example embodiments, as set forth above, are intended to be illustrative, not limiting. Various changes may be made without departing from the spirit and thereof. Therefore, example embodiments are intended to embrace all known or later-developed alternatives, modifications, variations, improvements, and/or substantial equivalents.

What is claimed is:

1. A computer-implemented system for the integration and deployment of software applications, comprising:
an extraction module for obtaining data and replicating it in a usable format, including business knowledge and rules from the application source code;
a conversion module for translating data from a legacy system to a new format, using Universal Application Notation (UAN);
a deployment module for installing, configuring, updating, and enabling applications for use, including automated deployment of newly translated applications; and
an integration module for seamlessly integrating new and legacy applications with a chatbot and/or low or no-code integration tools.

2. The system of claim 1, further comprising a metadata linking system for tracking and linking the origin and identity of individual software components from extraction to deployment.

3. A computer-implemented method for the integration and deployment of software applications, comprising:
extracting data and replicating it in a usable format, including business knowledge and rules from the application source code;
translating data from a legacy system to a new format, using Universal Application Notation (UAN);
deploying newly translated applications, including installing, configuring, and updating the applications for use; and
integrating new and legacy applications with a chatbot and/or low or no-code integration tools.

4. A computer-implemented method for managing the deployment of software applications, comprising:
receiving an application build request for a software application;
extracting software source code for the software application from a source code repository in response to the application build request;
performing automated security procedures to ensure integrity of the software source code elements;
combining the software source code elements into a requested baseline application build package in a secure build server;
storing the requested baseline application build package into an application product depot;
receiving a request to deploy at least one baseline application build package into a deployment environment;
extracting a copy of the at least one baseline application build package from the application product depot;
creating metadata to identify baseline application build packages to be installed into the destination deployment environment;
associating the metadata with the destination deployment environment;
installing the at least one baseline application build package and accompanying metadata into the deployment environment; and
linking the metadata with the specific baseline product build installed into the deployment environment.

5. The method of claim 4, wherein the automated security procedures include virus scanning and code validation to ensure the software source code is free from malicious code and complies with coding standards.

6. The method of claim 5, wherein the application build request includes a specification of software components to be included in the baseline application build package and the method further comprises verifying that the software components meet the compatibility requirements of the software application.

7. The method of claim 6, wherein the requested baseline application build package is encrypted and decrypted by the secure build server using cryptographic techniques to ensure confidentiality of the software source code.

8. The method of claim 7, wherein the destination deployment environment is a cloud-based infrastructure and the metadata includes parameters for configuring the deployment environment.

9. The method of claim 8, wherein the metadata includes a change log for the software application, including a record of all modifications to the software application and the personnel responsible for making the modifications.

10. The method of claim 9, wherein the metadata includes performance metrics for the software application in the deployment environment, including data on response times, processing speeds, and memory usage.

11. The method of claim 4, further comprising generating an alert in response to a detected failure in the software application in the deployment environment and tracing the failure back to the software source code used in the baseline application build package.

12. The method of claim 9, wherein the metadata includes a list of all supporting documents and tickets related to the baseline application build package.

13. The method of claim 4, wherein the software source code is versioned and the method further comprises identifying the version of the software source code used in the baseline application build package.

14. The method of claim 7, wherein the destination deployment environment is a virtual machine and the method further comprises creating a snapshot of the virtual machine before installing the baseline application build package, such that the virtual machine can be rolled back to the snapshot in the event of a failure.

15. A computer-implemented method for dynamically deploying software applications, comprising:
receiving a software file for deployment;
retrieving parameters associated with the software file;
configuring the software file for deployment based on the retrieved parameters;
determining the type of file being deployed and the runtime environment in which the application will execute;
performing any necessary additional operations based on the determined file type and runtime environment;
deploying the software file programmatically using the configured parameters and operations;
managing the software application as static content to reduce or eliminate manual operations during deployment.

16. The method of claim 15, wherein the retrieved parameters include the location of other files required for the software file to execute and the method further comprises retrieving the required files and configuring them for deployment.

17. The method of claim 15, wherein the retrieved parameters include the configuration settings of the runtime environment in which the software file will execute and the method further comprises configuring the runtime environment for the software file.

18. The method of claim 15, wherein the additional operations include compiling the software file.

19. The method of claim 15, wherein the determined file type is a business intelligence application and the necessary additional operations include configuring data sources.

20. The method of claim 15, wherein the method further comprises automatically testing the deployed software file to verify its functionality.

21. The method of claim 15, wherein the method further comprises generating an alert in response to a detected failure in the software file in the runtime environment.

22. The method of claim 15, wherein the method further comprises automatically updating the software file in the runtime environment when a new version of the software file is available.

23. The method of claim 15, wherein the runtime environment is a containerized environment and the method further comprises deploying the software file as a container.

24. The method of claim 15, wherein the method further comprises generating usage data for the deployed software file, including data on the number of requests, response times, and errors.
